(19) United States
(12) Patent Application Publication
(10) Pub. No.: US 2024/0152156 A1
(43) Pub. Date: May 9, 2024

(54) ELECTRONIC DEVICE FOR CONTROLLING CLEANING ROBOT, AND OPERATING METHOD THEREFOR

(71) Applicant: Samsung Electronics Co., Ltd., Suwon-si (KR)

(72) Inventor: Junghwi EUN, Suwon-si (KR)

(73) Assignee: Samsung Electronics Co., Ltd., Suwon-si (KR)

(21) Appl. No.: 18/412,847

(22) Filed: Jan. 15, 2024

Related U.S. Application Data
(63) Continuation of application No. PCT/KR2022/009780, filed on Jul. 6, 2022.

(30) Foreign Application Priority Data
Jul. 15, 2021 (KR) 10-2021-0093135

(51) Int. Cl. G05D 1/246; A47L 11/40; G05D 1/221; G05D 1/247; H04W 4/33

(52) U.S. Cl. CPC G05D 1/2462; A47L 11/4011; G05D 1/221; G05D 1/247; H04W 4/33; A47L 2201/04; G05D 2105/10

(57) ABSTRACT

An electronic apparatus for controlling a robot cleaner and an operation method thereof. The electronic apparatus that obtains position information, by using a wireless communication interface, based on at least one of a position of a position tracking tag device, a position of at least one home appliance located around the robot cleaner, and a relative position between the robot cleaner and the electronic apparatus, determines a target cleaning region based on the obtained position information, and transmits information about the determined target cleaning region to the robot cleaner.

### TECHNICAL FIELD

The present disclosure relates to an electronic apparatus for controlling a robot cleaner and an operation method thereof. In detail, embodiments of the present disclosure relate to an electronic apparatus that determines a target cleaning region that is a region to be cleaned by a robot cleaner in an indoor space and transmits information about the determined target cleaning region to the robot cleaner, and an operation method thereof.

### BACKGROUND ART

Recently, robot cleaners have been widely distributed and used. Functions such as target cleaning region setting, cleaning operation performing, and the like of a robot cleaner may be controlled through a dedicated remote controller. However, for robot cleaners with an IoT (Internet of Things) function, the robot cleaners may be controlled, or a target cleaning region may be set, remotely from the outside by using a mobile device connected through a wireless network, such as WiFi, Bluetooth, or the like.

As a method of setting a target cleaning region of a robot cleaner by using a mobile device, a method of directly selecting a region to be cleaned on a map of an indoor space displayed through an application executed by the mobile device, determining the size of the region through expansion or reduction of the region, and inputting a region addition button, is used. However, when using a robot cleaner, there may be a case of cleaning a specific region only. In this case, a user needs to go through several steps of thinking about a position for cleaning on a map displayed through a mobile device, directly selecting a region, directly determining the size of the region, inputting a region addition button, and the like.

### DISCLOSURE

### Technical Problem

The present disclosure provides an electronic apparatus that automatically sets a target cleaning region of a robot cleaner, and an operation method thereof.

### Technical Solution

To solve the technical object described above, the present disclosure provides an electronic apparatus for controlling a robot cleaner. An electronic apparatus according to an embodiment of the present disclosure may include a communication interface configured to perform data transceiving by using a wireless communication network, a memory to store at least one instruction, and at least one processor configured to execute the at least one instruction stored in the memory. In an embodiment of the present disclosure, the at least one processor may obtain position information, by using the communication interface, based on at least one of a position of a position tracking tag device, a position of at least one home appliance located around the robot cleaner, and a relative position between the robot cleaner and the electronic apparatus. In an embodiment of the present disclosure, the at least one processor may determine a target cleaning region based on the obtained position information. In an embodiment of the present disclosure, the at least one processor may control the communication interface to transmit information about the determined target cleaning region to the robot cleaner.

In order to solve the technical object described above, the present disclosure provides a method, performed by an electronic apparatus, of controlling a robot cleaner. In an embodiment of the present disclosure, the method of controlling a robot cleaner may include obtaining position information, by using a wireless communication network, based on at least one of a position of a position tracking tag device, a position of at least one home appliance located around the robot cleaner, and a relative position between the robot cleaner and the electronic apparatus. In an embodiment of the present disclosure, the method of controlling a robot cleaner may include determining a target cleaning region based on the obtained position information. In an embodiment of the present disclosure, the method of controlling a robot cleaner may include transmitting the determined information about a target cleaning region to the robot cleaner.

To solve the technical object described above, an embodiment of the present disclosure provides a computer program product including a non-transitory computer-readable storage medium having recorded thereon a program to be executed on a computer.

### DESCRIPTION OF DRAWINGS

The present disclosure may be readily understood from the following detailed description in conjunction with the accompanying drawings, and reference numerals denote structural elements.

FIG. 1 is a diagram illustrating a method, performed by an electronic apparatus according to an embodiment of the present disclosure, of determining a target cleaning region and transmitting information about the target cleaning region to a robot cleaner.

FIG. 2 is a block diagram of components of an electronic apparatus according to an embodiment of the present disclosure.

FIG. 3 is a flowchart illustrating an operation method of an electronic apparatus according to an embodiment of the present disclosure.

FIG. 4 is a diagram illustrating a method, performed by an electronic apparatus according to an embodiment of the present disclosure, of determining a target cleaning region of a robot cleaner based on a position of a position tracking tag device.

FIG. 5 is a diagram illustrating a method, performed by an electronic apparatus according to an embodiment of the present disclosure, of determining a target cleaning region of a robot cleaner based on position information of a home appliance.

FIG. 6 is a flowchart illustrating a method, performed by an electronic apparatus according to an embodiment of the present disclosure, of determining a target cleaning region of a robot cleaner based on position information of a home appliance.

FIG. 7 is a diagram illustrating a method, performed by an electronic apparatus according to an embodiment of the present disclosure, of determining an intensive target cleaning region based on information about the air quality of an indoor space.

FIG. 8A is a diagram illustrating a method, performed by an electronic apparatus according to an embodiment of the present disclosure, of obtaining relative position information between a robot cleaner and the electronic apparatus.

FIG. 8B is a diagram illustrating a method, performed by an electronic apparatus according to an embodiment of the present disclosure, of photographing a region to be cleaned and displaying the photographed region.

FIG. 8C is a diagram illustrating a method, performed by an electronic apparatus according to an embodiment of the present disclosure, of determining a target cleaning region based on relative position information with respect to a robot cleaner and a field of view (FOV) of a camera.

FIG. 9 is a flowchart illustrating a method, performed by an electronic apparatus according to an embodiment of the present disclosure, of determining a target cleaning region based on a relative positional relationship with a robot cleaner and the FOV of a camera.

FIG. 10 is a diagram illustrating a method, performed by an electronic apparatus according to an embodiment of the present disclosure, of controlling a robot cleaner to perform a cleaning operation on a target cleaning region based on a voice input received from a user.

FIG. 11 is a flowchart illustrating a method, performed by an electronic apparatus according to an embodiment of the present disclosure, of controlling a robot cleaner to perform a cleaning operation on a target cleaning region.

### MODE FOR INVENTION

The terms used in the present disclosure have been selected from currently widely used general terms in consideration of the functions in the present disclosure. However, the terms may vary according to the intention of one of ordinary skill in the art, case precedents, and the advent of new technologies. Also, for special cases, meanings of the terms selected by the applicant are described in detail in the description section. Accordingly, the terms used in the present disclosure are defined based on their meanings in relation to the contents discussed throughout the specification, not by their simple meanings.

An expression used in a singular form in the specification also includes the expression in its plural form unless clearly specified otherwise in context. All terms used herein including technical or scientific terms have the same meanings as those generally understood by those of ordinary skill in the art to which the present disclosure may pertain.

In the entire disclosure, when a part may “include” a certain constituent element, unless specified otherwise, it may not be construed to exclude another constituent element but may be construed to further include other constituent elements. Furthermore, terms such as “ . . . portion,” “ . . . module,” and the like stated in the specification may signify a unit to process at least one function or operation and the unit may be embodied by hardware or software, or a combination of hardware and software.

In the specification, the expression “configured to” may be interchangeable with an expression such as “suitable for,” “having the capacity to,” “designed to,” “adapted to,” “made to,” or “capable of.” The expression “configured to” does not necessarily signify one that is “specifically designed to” in hardware. Instead, in some situations, the expression “configured to” may signify one that is “capable of” performing a function with other device or parts. For example, an expression “a processor configured to perform functions A, B, and C” may signify an exclusive processor, for example, an embedded processor, for performing the functions or a generic-purpose processor, for example, a CPU or an application processor, capable of performing the functions by executing one or more software programs stored in a memory device.

The embodiment of the present disclosure is described with reference to the accompanying drawings so that one skilled in the art to which the present disclosure pertains can work the present disclosure. However, the present disclosure is not limited thereto and it will be understood that various changes in form and details may be made therein without departing from the spirit and scope of the following claims.

The embodiments of the present disclosure are described in detail.

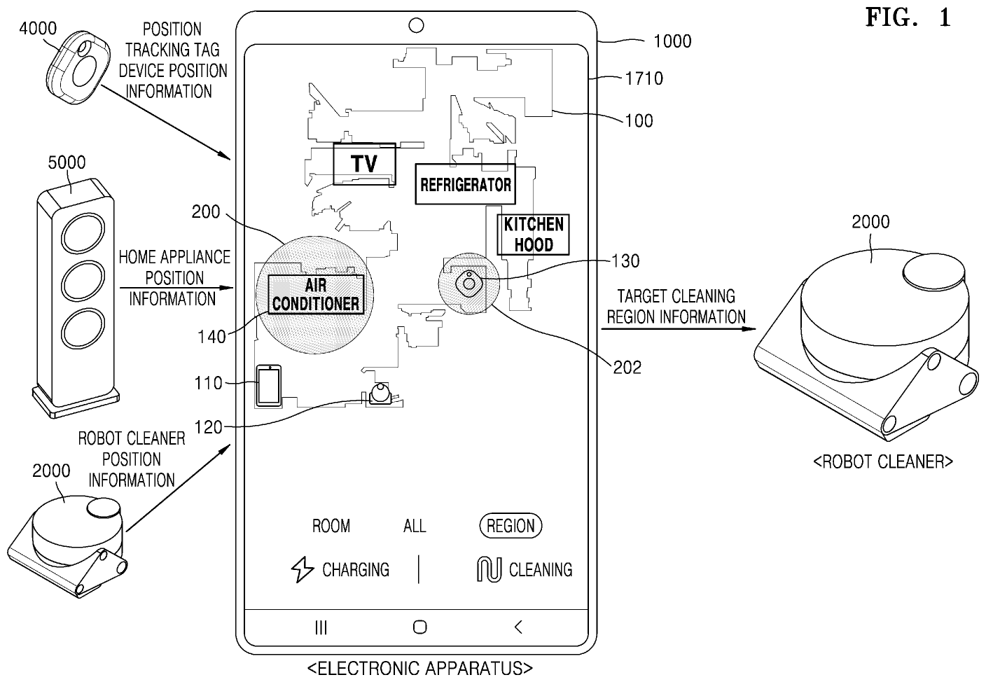

FIG. 1 is a diagram illustrating a method, performed by an electronic apparatus 1000 according to an embodiment of the present disclosure, of determining a target cleaning region and transmitting information about the target cleaning region to a robot cleaner 2000.

The electronic apparatus 1000 according to an embodiment of the present disclosure may transceive information with a server or an external device (e.g., the robot cleaner 2000, a position tracking tag device 4000, or a home appliance 5000) through an installed specific application, and control the operation of the robot cleaner 2000. In an embodiment, the specific application may be an application that provides functions by which a user may determine a target cleaning region of the robot cleaner 2000, or remotely control a cleaning operation of the robot cleaner 2000.

According to an embodiment of the present disclosure, the electronic apparatus 1000 may be an apparatus connected to the robot cleaner 2000 with the same user account information (user account). The electronic apparatus 1000 may be directly connected to the robot cleaner 2000 through a short-range communication link, or indirectly to the robot cleaner 2000 through a server. The electronic apparatus 1000 may be connected to the robot cleaner 2000, a server or external devices, by using at least one data communication network, for example, wireless Lan, Wi-Fi, Bluetooth, Zigbee, Wi-Fi direct (WFD), Bluetooth low energy (BLE), wireless broadband Internet (Wibro), world interoperability for microwave access (WiMAX), shared wireless access protocol (SWAP), wireless gigabit alliance (WiGig), and an RF communication, and may perform data transceiving.

The electronic apparatus 1000 according to an embodiment of the present disclosure may be implemented in various forms. For example, the electronic apparatus 1000 of the present disclosure may be any one of mobile terminals including smart phones, tablet PCs, laptop computers, digital cameras, e-book terminals, digital broadcast terminals, personal digital assistants (PDA), portable multimedia players (PMP), navigation devices, or MP3 players, but the present disclosure is not limited thereto. In an embodiment, the electronic apparatus 1000 may be a wearable device. Wearable devices may include at least one of accessory type devices (e.g., watches, rings, bracelets, anklets, necklaces, glasses, and contact lenses), head-mounted devices (HMD), textile or clothing integrated devices (e.g. electronic garments), body-worn devices (e.g., skin pads), or bio-implantable devices (e.g. implantable circuits). In another embodiment, the electronic apparatus 1000 may be implemented as TVs, computers, refrigerators with a display, ovens with a display, or the like.

In the following description, for convenience of explanation, a case in which the electronic apparatus 1000 is a smart phone is described as an example.

Referring to FIG. 1, the electronic apparatus 1000 may determine a target cleaning region based on at least one of the position of the position tracking tag device 4000, the position of the home appliance 5000, and a relative position between the robot cleaner 2000 and the home appliance 5000, and transmit information about the target cleaning region to the robot cleaner 2000.

The electronic apparatus 1000 may receive the position information of the position tracking tag device 4000 directly from the position tracking tag device 4000, or from a server. The ‘position tracking tag device 4000’, as a portable tracker device, is a device configured to provide position coordinates information to the electronic apparatus 1000. The position tracking tag device 4000 may be, for example, Galaxy Smart Tag™, but the present disclosure is not limited thereto. In an embodiment, the electronic apparatus 1000 may identify the position of the position tracking tag device 4000 from position coordinates information received from the position tracking tag device 4000, and determine an area within a preset range from the identified position to be a target cleaning region. For example, the electronic apparatus 1000 may determine a region within a radial range of 1 m or 2 m from the position of the position tracking tag device 4000 to be a target cleaning region.

The electronic apparatus 1000 may obtain the position information of the home appliance 5000. In an embodiment, the electronic apparatus 1000 may receive from the robot cleaner 2000 the position information of the at least one home appliance 5000 arranged around the robot cleaner 2000. The electronic apparatus 1000 may determine an area within a preset range from the position of the home appliance 5000 to be a target cleaning region. For example, the electronic apparatus 1000 may determine a region within a radial range of 1 m or 2 m from the position of the home appliance 5000 to be a target cleaning region.

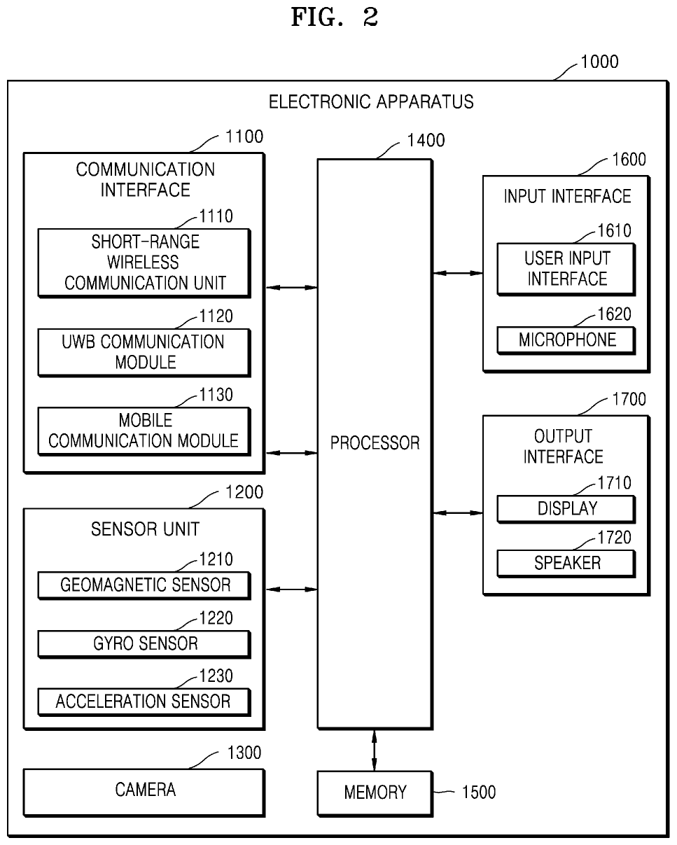

The electronic apparatus 1000 may obtain relative position information between the robot cleaner 2000 and the electronic apparatus 1000. The ‘relative position between the robot cleaner 2000 and the electronic apparatus 1000’ may refer to the position information of the robot cleaner 2000 with respect to the position of the electronic apparatus 1000. The relative position information between the robot cleaner 2000 and the electronic apparatus 1000 may include information about a distance from the electronic apparatus 1000 to the robot cleaner 2000 and information about an angle formed between the electronic apparatus 1000 and the robot cleaner 2000. In an embodiment, the electronic apparatus 1000 may receive the position coordinates information of the robot cleaner 2000 from the robot cleaner 2000 by using an ultra wide band (UWB) communication network, and obtain the relative position information to the robot cleaner 2000 based on the received position coordinates information of the robot cleaner 2000 and the direction and inclination angle information of the electronic apparatus 1000. The electronic apparatus 1000 may photograph a region to be cleaned through a camera 1300 (see FIG. 2), and identify the position of the photographed region based on the relative position information between the robot cleaner 2000 and the electronic apparatus 1000 and the position of the photographed region based on the field of view (FOV) of the camera 1300. The electronic apparatus 1000 may determine the identified photographed region to be a target cleaning region.

The electronic apparatus 1000 may transmit information about the determined target cleaning region to the robot cleaner 2000.

The electronic apparatus 1000 may display an indoor space map 100 on a display 1710. The indoor space map 100 may be generated as the robot cleaner 2000 searches the indoor space by using at least one sensor while moving in the indoor space. The electronic apparatus 1000 may obtain indoor space information from the robot cleaner 2000, and display the indoor space map 100. A user interface (UI) that shows the electronic apparatus 1000, the robot cleaner 2000, the position tracking tag device 4000, and the position of the home appliance 5000 may be displayed on the indoor space map 100. In an embodiment, UIs may be graphic UIs. In the embodiment illustrated in FIG. 1, an electronic apparatus icon 110 representing the position of the electronic apparatus 1000, a robot cleaner icon 120 representing the position of the robot cleaner 2000, a position tracking tag device icon 130 representing the position of the position tracking tag device 4000, and a home appliance icon 140 representing the position of the home appliance 5000 may be displayed on the indoor space map 100. In an embodiment, the indoor space map 100 may display target cleaning region indicators 200 and 202 that visually indicate the determined target cleaning regions.

The electronic apparatus 1000 may receive a user's input for selecting any one of the target cleaning region indicators 200 and 202 displayed on the display 1710. The electronic apparatus 1000 may generate a control command to control the robot cleaner 2000 to perform a cleaning operation on a target cleaning region selected according to the received user's input, and transmit the control command to the robot cleaner 2000. The ‘control command’ may refer to instructions that are readable and executable by the robot cleaner 2000 so that the robot cleaner 2000 can perform detailed operations included in operation information. In an embodiment, the control command may further include not only position information about a target cleaning region, but also at least one of a cleaning command for a target cleaning region, a return command to a charging station, a direction change command, or a command to perform cleaning in a specific operation mode (e.g., an intensive mode, a general mode, or a repetition mode).

In the embodiment described above, although the electronic apparatus 1000 is described to transmit a control command to perform cleaning on a target cleaning region through a user's input of selecting the target cleaning region indicators 200 and 202 displayed on the display 1710, the present disclosure is not limited thereto. In an embodiment, the electronic apparatus 1000 may receive a voice input uttered by a user for a target cleaning region. The electronic apparatus 1000 may identify a target cleaning region based on the natural language interpretation result of the voice input, and generate a control command to control the robot cleaner 2000 to perform a cleaning operation on the target cleaning region.

In the embodiments described above, when a cleaning command for a target cleaning region from a user, the electronic apparatus 1000 is described to transmit a control command to the robot cleaner 2000, but the present disclosure is not limited to the embodiments described above. In an embodiment, the electronic apparatus 1000 may control the robot cleaner 2000 to automatically clean a target cleaning region without a user's input.

For the existing robot cleaners, adopted is a method of directly selecting a region to be cleaned on the indoor space map 100 displayed on display 1710, directly determining the size of a region through the expansion or reduction of a region, and determining a target cleaning region by inputting a region addition button. However, in the method, as a user needs to go through several steps of thinking a position to be cleaned on the indoor space map 100, directly selecting a region, directly determining the size of a region, inputting a region addition button, and the like, it is a problem that the process is cumbersome and inconvenient so that user convenience deteriorates.

As the electronic apparatus 1000 according to an embodiment of the present disclosure automatically determines a target cleaning region based on at least one of the position of the position tracking tag device 4000, the position of the home appliance 5000, and the relative position between the robot cleaner 2000 and the electronic apparatus 1000, a cumbersome and inconvenient process of directly determining a target cleaning region may be omitted. Accordingly, an electronic apparatus 1000 according to an embodiment of the present disclosure may improve user convenience.

FIG. 2 is a block diagram of the components of the electronic apparatus 1000 according to an embodiment of the present disclosure.

The electronic apparatus 1000 is configured to determine a target cleaning region based on at least one of the position of the position tracking tag device 4000 (see FIG. 1), the position of the home appliance 5000 (see FIG. 1), and the relative position between the robot cleaner 2000 (see FIG. 1) and the home appliance 5000, and transmit information about the target cleaning region to the robot cleaner 2000.

Referring to FIG. 2, the electronic apparatus 1000 may include a communication interface 1100, a sensor unit 1200, the camera 1300, a processor 1400, a memory 1500, an input interface 1600, and an output interface 1700. The communication interface 1100, the sensor unit 1200, the camera 1300, the processor 1400, the memory 1500, the input interface 1600, and the output interface 1700 may be electrically and/or physically connected to one another.

The components illustrated in FIG. 2 are merely according to an embodiment of the present disclosure, but the components included in the electronic apparatus 1000 are not limited to those illustrated in FIG. 2. The electronic apparatus 1000 may not include some of the components illustrated in FIG. 2, or may further include components that are not illustrated in FIG. 2. For example, the electronic apparatus 1000 may further include a GPS module for obtaining position information.

The communication interface 1100 is configured to perform data communication with the robot cleaner 2000 (see FIG. 1), a server or an external device (e.g., the position tracking tag device 4000 of FIG. 1), or the home appliance 5000 (see FIG. 1)). The communication interface 1100 may include a short-range wireless communication unit 1110, a UWB communication module 1120, and a mobile communication module 1130.

The short-range wireless communication unit 1110 may be configured as at least one hardware device among a WiFi, a Wi-Fi Direct (WFD) communication unit, a Bluetooth communication unit, a Bluetooth Low Energy (BLE) communication unit, a near field communication (NFC) unit, a Zigbee communication unit, an Ant+ communication unit, or a microwave (pWave) communication unit. However, the present disclosure is not limited thereto. In an embodiment, the short-range wireless communication unit 1110 may receive the position information of the robot cleaner 2000 from the robot cleaner 2000 under the control of the processor 1400.

The short-range wireless communication unit 1110 may perform data communication with an external server through a gateway or a router.

In an embodiment, the short-range wireless communication unit 1110 may receive the position information of the position tracking tag device 4000 under the control of the processor 1400. For example, the short-range wireless communication unit 1110 may receive position coordinates information from the position tracking tag device 4000 by using a BLE communication. However, the present disclosure is not limited thereto, and the short-range wireless communication unit 1110 may receive the position coordinates information of the position tracking tag device 4000 from a server.

The UWB communication module 1120 is a communication device for performing data transceiving by using an UWB frequency range between 3.1 GHz to 10.6 GHz. The UWB communication module 1120 may be configured as a hardware device. The UWB communication module 1120 may transceive data at a maximum speed of 500 Mbps. In an embodiment, the UWB communication module 1120 may receive the position coordinates information of the robot cleaner 2000, from the robot cleaner 2000, by using an UWB frequency. In an embodiment, the UWB communication module 1120 may transmit the position coordinates information of the electronic apparatus 1000 to the robot cleaner 2000 under the control of the processor 1400.

The mobile communication module 1130 is a communication device configured to transceive wireless signals with at least one of a base station, an external device, or a server, on a mobile communication network. The mobile communication module 1130 may be configured as a hardware device. The mobile communication module 1130 may transceive data by using at least one communication method of, for example, 5G mmWave communication, 5G Sub 6 communication, long term evolution (LTE) communication, or 3G mobile communication. In an embodiment, the mobile communication module 1130 may transceive data with a server under the control of the processor 1400.

The sensor unit 1200 is a sensor device configured to measure at least one of the direction, inclination angle, and acceleration of gravity of the electronic apparatus 1000. The sensor unit 1200 may include a geomagnetic sensor 1210, a gyro sensor 1220, and an acceleration sensor 1230.

The geomagnetic sensor 1210 is configured to measure the direction of the electronic apparatus 1000. The geomagnetic sensor 1210 may obtain information about the direction of the electronic apparatus 1000 by measuring a magnetic value of the earth magnetic field in X-axis, Y-axis, and Z-axis directions.

The processor 1400 may obtain azimuth information about the direction that the electronic apparatus 1000 faces, by using the magnetic value measured by the geomagnetic sensor 1210. The processor 1400 may obtain information about the height of the electronic apparatus 1000 by using the geomagnetic sensor 1210. In an embodiment, the processor 1400 may display azimuth information through a compass application.

The gyro sensor 1220 is configured to measure the rotation angle or inclination angle of the electronic apparatus 1000. In an embodiment, the gyro sensor 1220 may include a 3-axis gyrometer for measuring roll, pitch, and yaw angular velocities.

The acceleration sensor 1230 is configured to measure the inclination angle of the electronic apparatus 1000, by measuring the 3-axis acceleration of the electronic apparatus 1000. In an embodiment, the acceleration sensor 1230 may include a 3-axis accelerometer for measuring acceleration in a row direction, a transverse direction, and a height direction.

The processor 1400 may obtain information about the rotation angle or inclination angle of the electronic apparatus 1000 by using the gyro sensor 1220 and the acceleration sensor 1230 together.

The camera 1300 is configured to photograph the indoor space. The camera 1300 may include at least one of, for example, a stereo camera, a mono camera, a wide angle camera, an around view camera, or a 3D vision sensor.

The processor 1400 may execute one or more instructions or program code stored in the memory 1500, and perform functions and/or operations corresponding to the instructions or program code. The processor 1400 may be configured as hardware components that perform arithmetic, logic, and input/output operations, and signal processing. The processor 1400 may include at least one of, for example, a central processing unit, a microprocessor, a graphic processing unit, an application processor (AP), application specific integrated circuits (ASICs), digital signal processors (DSPs), digital signal processing devices (DSPDs), programmable logic devices (PLDs), and field programmable gate arrays (FPGAs), but the present disclosure is not limited thereto.

Although FIG. 2 illustrates that the processor 1400 is one element, the present disclosure is not limited thereto. In an embodiment, the processor 1400 may include a single process or a plurality of processors.

In an embodiment, the processor 1400 may be configured as a dedicated hardware chip that performs artificial intelligence (AI) training.

The memory 1500 may store instructions and program code that are read by the processor 1400. The memory 1500 may include, for example, at least one type of storage media such as a flash memory type, a hard disk type, a multimedia card micro type, ora card type memory (e.g., an SD or XD memory and the like), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disc.

In the following embodiment, the processor 1400 may execute and implement instructions or program code of a program stored in the memory 1500.

The processor 1400 may obtain, by using the communication interface 1100, information about at least one of the position of the position tracking tag device 4000 (see FIG. 1), the position of the home appliance 5000 (see FIG. 1), and the relative position between the robot cleaner 2000 and the electronic apparatus 1000, and may determine a target cleaning region based on the obtained at least one position. In an embodiment, the processor 1400 may determine an area within a preset range as a target cleaning region from at least one position. The processor 1400 may control the communication interface 1100 to transmit information about the determined target cleaning region to the robot cleaner 2000.

In an embodiment, the processor 1400 may obtain the position information of the position tracking tag device 4000 (see FIG. 1) through the short-range wireless communication unit 1110. The processor 1400 may be directly connected to the position tracking tag device 4000 through, for example, BLE communication. In this case, the processor 1400 may obtain position coordinates information from the position tracking tag device 4000 by using a BLE communication.

However, the present disclosure is not limited thereto, and in another embodiment, the processor 1400 may obtain the position coordinates information of the position tracking tag device 4000 from a server through the short-range wireless communication unit 1110. In this case, the position tracking tag device 4000 may be a device that is preregistered on a server through a user account of the electronic apparatus 1000 and connected to the electronic apparatus 1000 through a server.

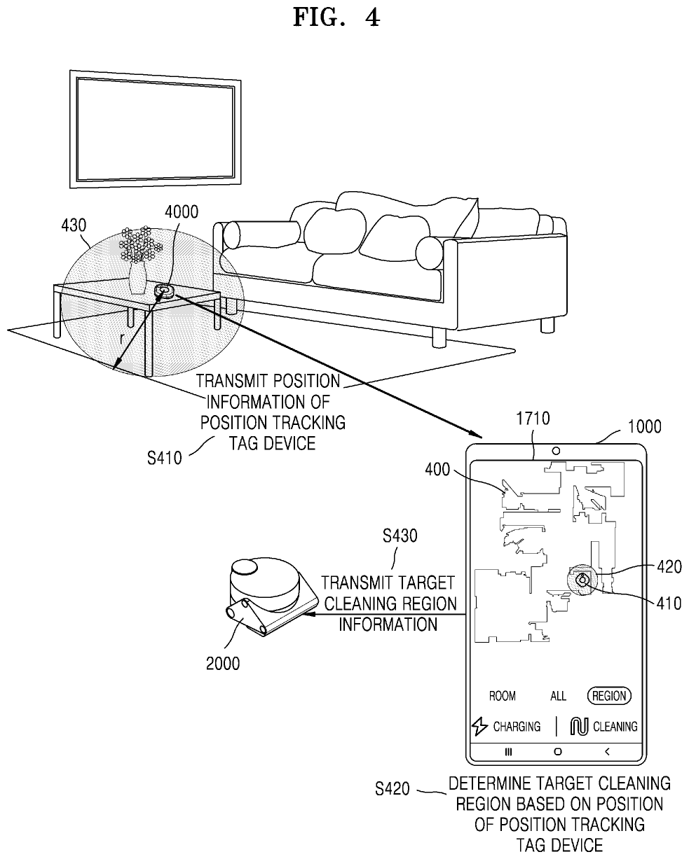

In an embodiment, the processor 1400 may identify the position of the position tracking tag device 4000 from the obtained position coordinates information of the position tracking tag device 4000, and determine a region within a preset radius with respect to the identified position of the position tracking tag device 4000 as a target cleaning region. The processor 1400 may determine, for example, a region within a distance of 1 m or 2 m with respect to the position of the position tracking tag device 4000, as a target cleaning region. A specific embodiment in which the processor 1400 determines a target cleaning region based on the position of the position tracking tag device 4000 is described in detail in FIG. 4.

In an embodiment, the processor 1400 may obtain the position information of the home appliance 5000 (see FIG. 1) from the robot cleaner 2000 through the short-range wireless communication unit 1110. The robot cleaner 2000 may obtain the position information of the at least one home appliance 5000 arranged around the robot cleaner 2000 while moving in the indoor space. In an embodiment, the robot cleaner 2000 may estimate the position information of the at least one home appliance 5000 based on communication strength information output from the at least one home appliance 5000 arranged nearby. For example, the robot cleaner 2000 may include a short-range wireless communication unit to perform a short-range wireless communication with the at least one home appliance 5000, and estimate the position of the at least one home appliance 5000 based on a received signal strength indication (RSSI) of a signal received from the at least one home appliance 5000 through the short-range wireless communication unit. The processor 1400 may receive the position information of each of the at least one home appliance 5000, from the robot cleaner 2000, through at least one of short-range wireless communication networks, for example, WiFi, WFD, Bluetooth, BLE, NFC, Zigbee, or μWave communication. The processor 1400 may determine an area within a preset range as a target cleaning region with respect to the position of each of the at least one home appliance 5000. The processor 1400 may determine, for example, a region within a radius of 1 m or 2 m with respect to the position of a refrigerator, as a target cleaning region.

In an embodiment, the robot cleaner 2000 may obtain device identification information of each of the at least one home appliance 5000, and transmit the obtained device identification information to the electronic apparatus 1000. The processor 1400 may receive the device identification information of the at least one home appliance 5000 from the robot cleaner 2000 by using the short-range wireless communication unit 1110, and identify the type of each of the at least one home appliance 5000 based on the received device identification information. The processor 1400 may control the display 1710 to display a user interface (UI) representing the identified type and position of each of the at least one home appliance 5000 on the indoor space map.

The processor 1400 may receive a user's input to select any one type of the at least one home appliance 5000 through the UI displayed on the display 1710. In an embodiment, the processor 1400 may receive user's touch input through a user's input interface 1610, or receive a voice input consisting of user's utterance through a microphone 1620.

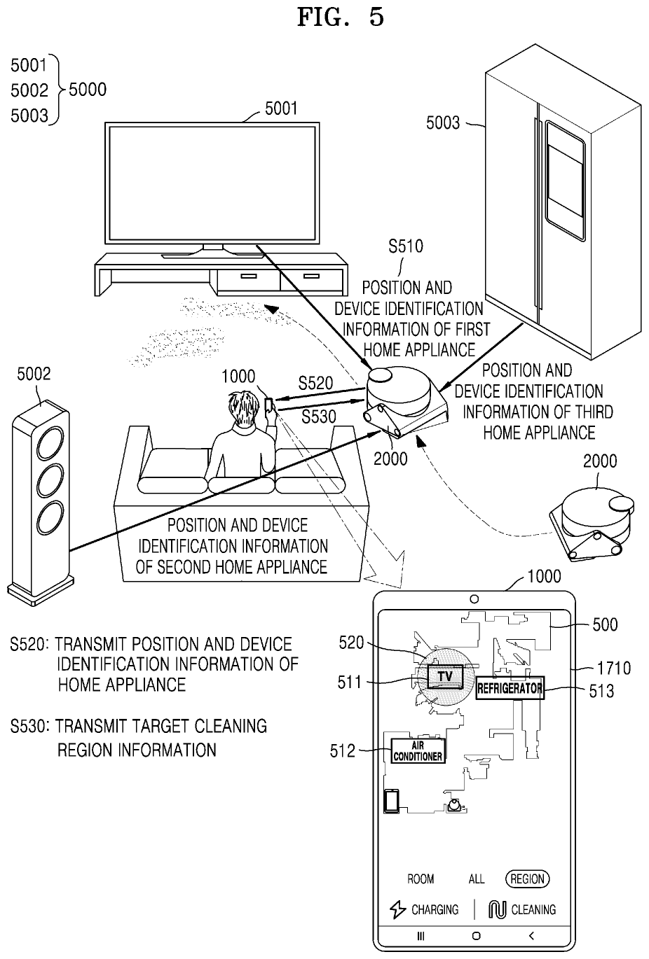

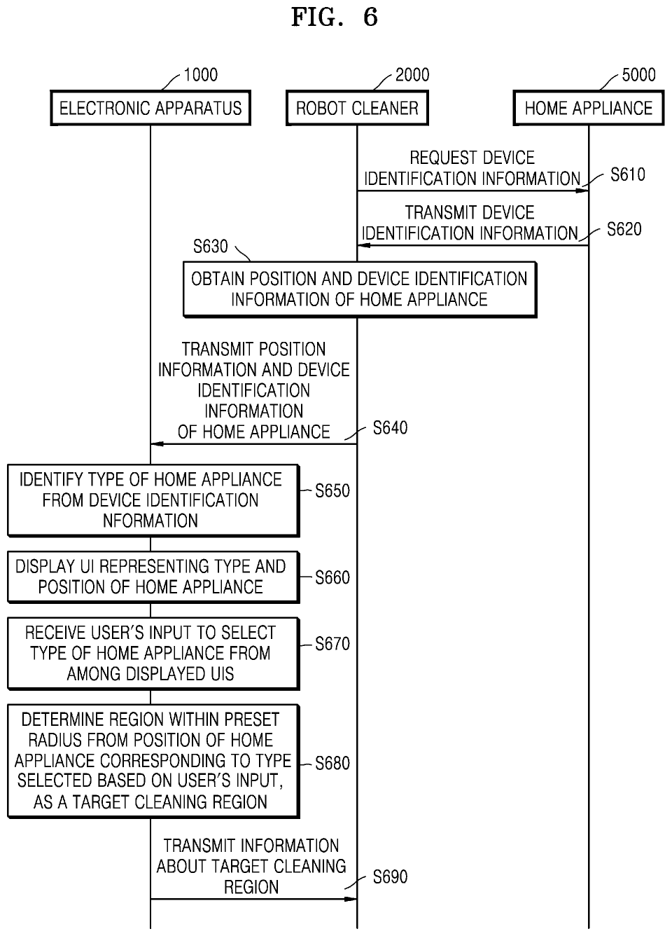

The processor 1400 may identify the position of a home appliance corresponding to the type selected based on the user's input, and determine a region within a preset radius from the identified position of the home appliance as a target cleaning region. For example, the processor 1400 may receive a user's input to select a television ((TV) icon from among a refrigerator icon, a TV icon, and an air conditioner icon which are displayed on the display 1710, identify the position of a TV that is a home appliance corresponding to the TV icon selected based on the user's input, and determine a region within a radius of 1 m or 2 m from the position of the TV as a target cleaning region. A specific embodiment in which the processor 1400 determines a target cleaning region based on the type and position information of a home appliance is described in detail with reference to FIGS. 5 and 6.

In an embodiment, the processor 1400 may obtain the position information of the robot cleaner 2000 from the robot cleaner 2000 through the UWB communication module 1120. The processor 1400 may obtain the information about the direction of the electronic apparatus 1000 by using the geomagnetic sensor 1210, and information about the inclination angle of the electronic apparatus 1000 by using the gyro sensor 1220 and the acceleration sensor 1230. The processor 1400 may obtain the relative position information between the robot cleaner 2000 and the electronic apparatus 1000, based on the position information of the robot cleaner 2000 and the information about the direction and inclination angle of the electronic apparatus 1000. The ‘relative position between the robot cleaner 2000 and the electronic apparatus 1000’ may refer to the position information of the robot cleaner 2000 with respect to the position of the electronic apparatus 1000. The relative position information between the robot cleaner 2000 and the electronic apparatus 1000 may include the information about a distance from the electronic apparatus 1000 to the robot cleaner 2000 and the information about an angle formed between the electronic apparatus 1000 and the robot cleaner 2000.

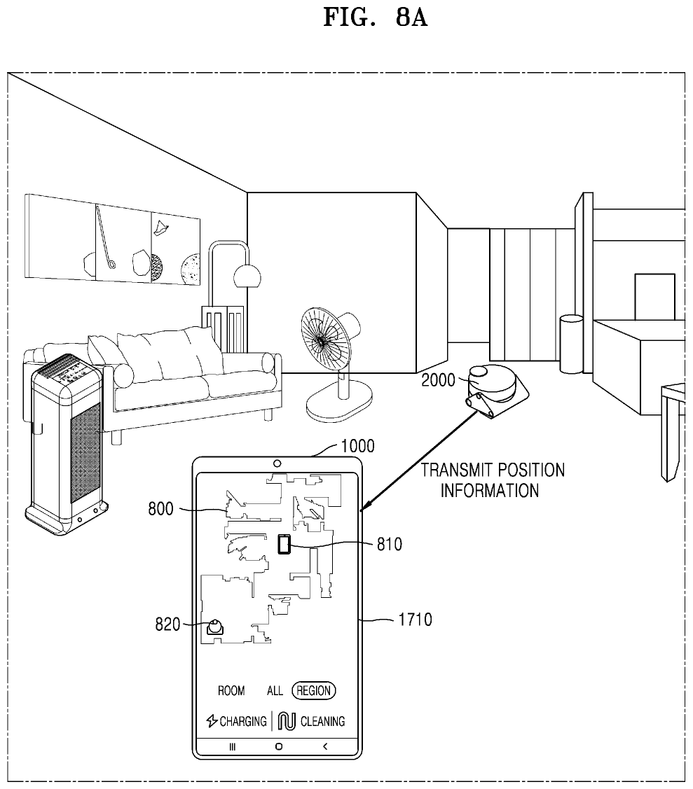

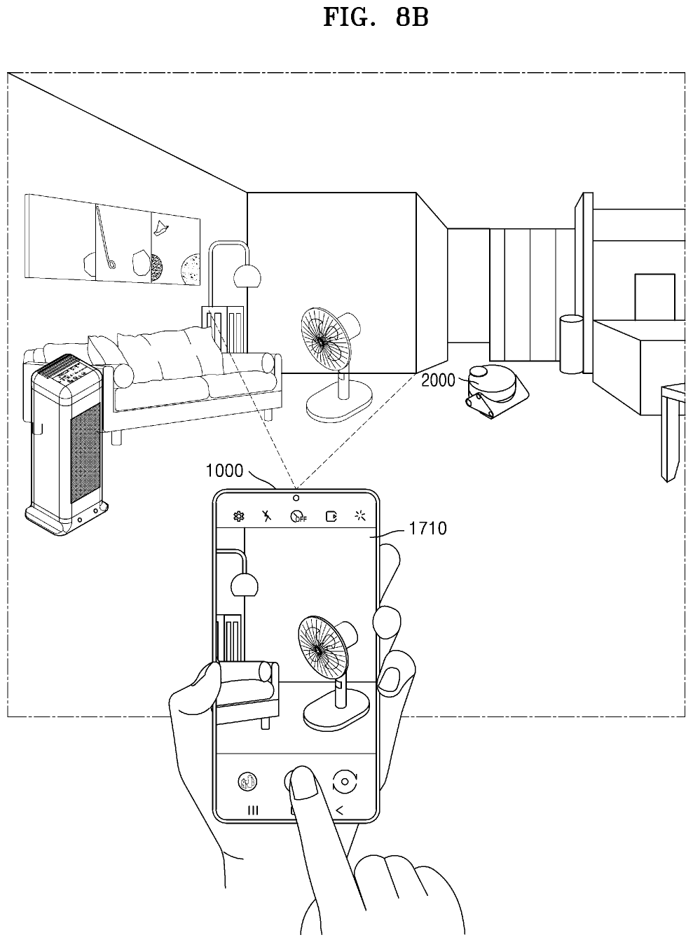

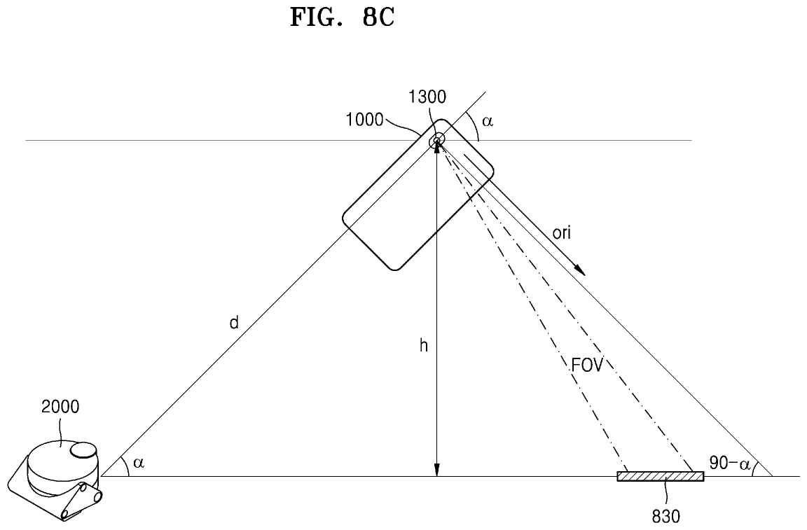

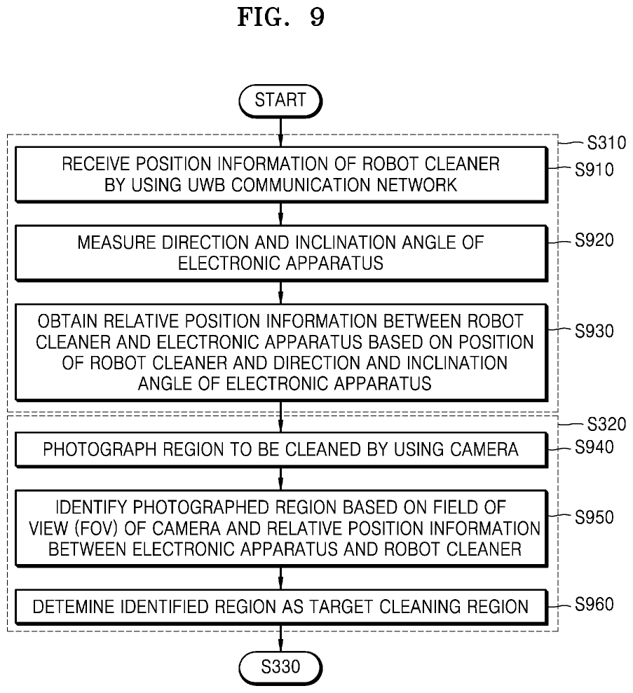

In an embodiment, the processor 1400 may identify the position of a region photographed by the camera 1300, based on the field of view (FOV) of the camera 1300 and the relative position information to the robot cleaner 2000. The processor 1400 may determine the identified region as a target cleaning region. A specific embodiment in which the processor 1400 determines a target cleaning region based on the FOV of the camera 1300 and the relative position information between the robot cleaner 2000 and the electronic apparatus 1000 is described in detail with reference to FIGS. 8A to 8C and 9.

In an embodiment, the processor 1400 may receive a voice input including a cleaning command for a target cleaning region, and identify a cleaning command from the received voice input. The processor 1400 may receive a voice input uttered by a user through the microphone 1620. The processor 1400 may transmit voice signal data converted from the voice input to a server by using the communication interface 1100, and receive a natural language interpretation result of the voice signal data from the server. The processor 1400 may identify a cleaning command based on the received natural language interpretation result of the voice signal data.

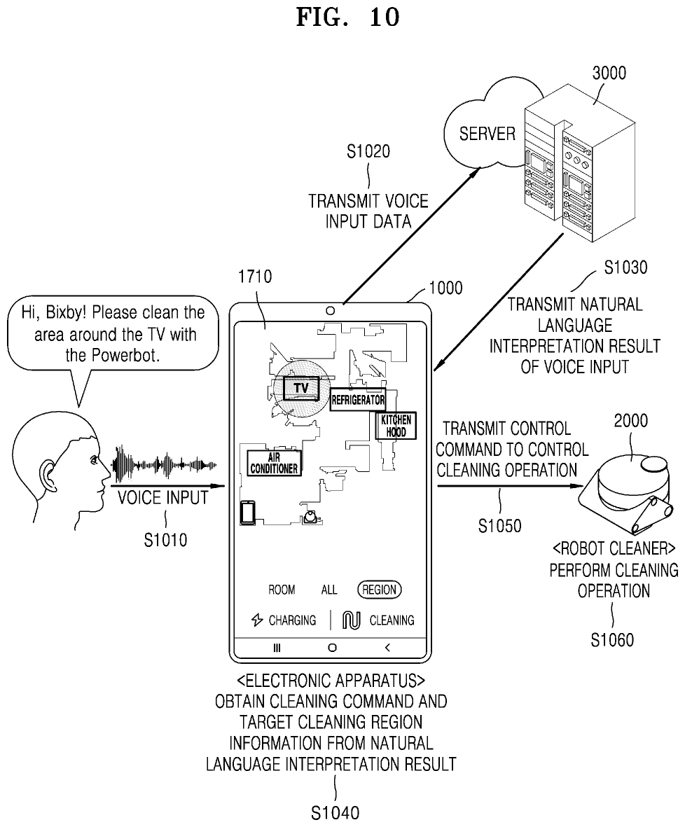

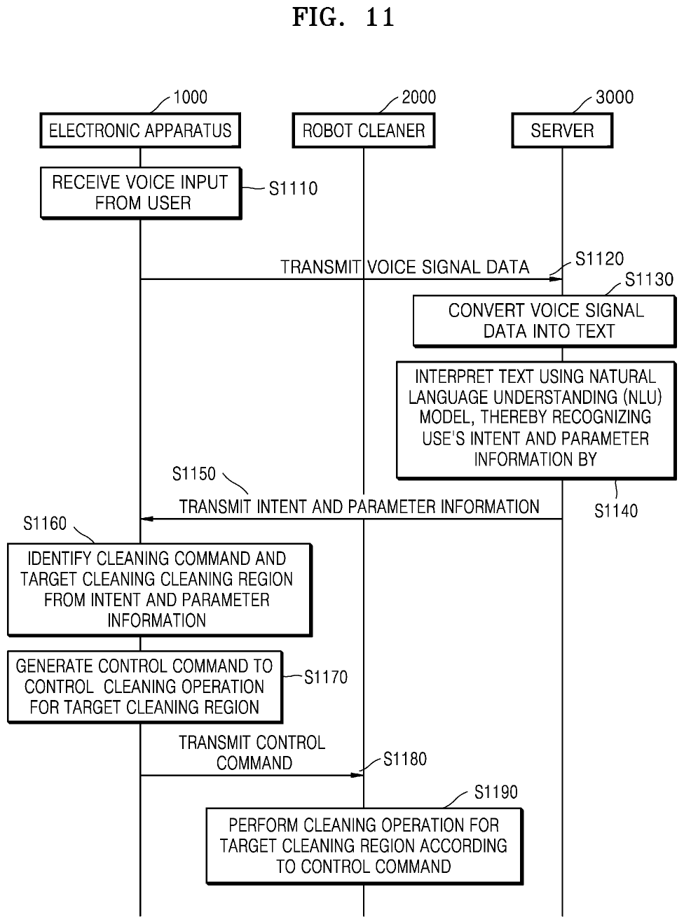

The processor 1400 may generate a control command to control the robot cleaner 2000 to perform a cleaning operation on a target cleaning region according to the cleaning command. The ‘control command’ means instructions that are readable and executable by an operation performing device so that the operation performing device (e.g., the robot cleaner 2000) can perform detailed operations included in operation information. In an embodiment, the control command may further include not only the position information about a target cleaning region, but also at least one of a cleaning command for a target cleaning region, a return command to a charging station, a direction change command, or a command to perform cleaning in a specific operation mode (e.g., an intensive mode, a general mode, or a repetition mode). The processor 1400 may control the communication interface 1100 to transmit the control command to the robot cleaner 2000. A specific embodiment in which the processor 1400 receives a voice input for a cleaning command from a user, and transmits a control command related to a cleaning operation to the robot cleaner 2000 in response to the voice input is described in detail with reference to FIG. 10 and In FIG. 11.

The input interface 1600 may be configured to receive a selection input from a user. In an embodiment, the input interface 1600 may receive a user's input to select any one of the type of the at least one home appliance 5000, or receive a user's input to select a target cleaning region for a cleaning command. The input interface 1600 may include the user's input interface 1610 and the microphone 1620.

The user's input interface 1610 may be configured as hardware, such as a key pad, a touch pad, a trackball, a jog switch, and the like, but the present disclosure is not limited thereto. In an embodiment, the user's input interface 1610 may be configured as a touch screen that receives a touch input and displays a graphical user interface (GUI).

The microphone 1620 may be configured to receive a voice input (e.g., user's utterance) from a user. The microphone 1620 may obtain a voice signal from the received voice input. In an embodiment, the microphone 1620 may convert the received voice input into a sound signal and remove noise (e.g., a non-voice component) from the sound signal, thereby obtaining a voice signal. The microphone 1620 provides a voice signal to the processor 1400.

The output interface 1700 may be configured to output a video signal or an audio signal. The output interface 1700 may include the display 1710 and a speaker 1720.

The display 1710 may display an indoor space map that visually shows the indoor space. In an embodiment, the display 1710 may display, under the control of the processor 1400, an indicator UI (e.g., icon) representing the position of the robot cleaner 2000 and an indicator UI representing the type and position of a home appliance, on the indoor space map. In an embodiment, the display 1710 may display, under the control of the processor 1400, an indicator UI representing a target cleaning region, on the indoor space map.

The display 1710 may be configured as a physical device including at least one of, for example, a liquid crystal display, a thin film transistor-liquid crystal display, an organic light-emitting diode, a flexible display, a 3D display, an electrophoretic display, but the present disclosure is not limited to the listed examples. In an embodiment, the display 1710 may be configured as a touch screen including a touch interface. When the display 1710 is configured as a touchscreen, the display 1710 may be a component integrated with the user's input interface 1610 provided as a touch panel.

The speaker 1720 may output an audio signal.

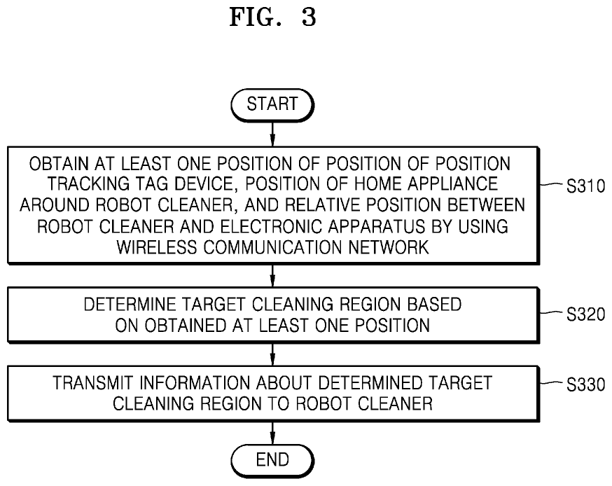

FIG. 3 is a flowchart of an operation method of the electronic apparatus 1000 according to an embodiment of the present disclosure.

In operation S310, the electronic apparatus 1000 obtains at least one position of the position of a position tracking tag device, the position of a home appliance around a robot cleaner, and a relative position between a robot cleaner and an electronic apparatus, by using a wireless communication network. In an embodiment, the electronic apparatus 1000 may receive position information of a position tracking tag device directly from a position tracking tag device or from a server. For example, the electronic apparatus 1000 may receive the position information of a position tracking tag device directly from the position tracking tag device, by using a BLE communication method.

In an embodiment, the electronic apparatus 1000 may obtain the position information about at least one home appliance obtained by the robot cleaner 2000 (see FIG. 1), through a short-range wireless communication network. The electronic apparatus 1000 may receive position information of each of at least one home appliance from the robot cleaner 2000 through at least one short-range wireless communication network of, for example, WiFi, WFD, Bluetooth, BLE, NFC, Zigbee, or μWave communication.

In an embodiment, the electronic apparatus 1000 may obtain the position information of the robot cleaner 2000 from the robot cleaner 2000 by using an UWB communication network, and may obtain the relative position information between the robot cleaner 2000 and the electronic apparatus 1000 based on the obtained position information of the robot cleaner 2000 and the direction and inclination angle information of the electronic apparatus 1000. In an embodiment, the electronic apparatus 1000 may obtain the azimuth information of the electronic apparatus 1000 by using the geomagnetic sensor 1210 (see FIG. 2), and obtain the inclination angle or rotation angle information of the electronic apparatus 1000 by using the gyro sensor 1220 (see FIG. 2) and the acceleration sensor 1230 (see FIG. 2).

In operation S320, the electronic apparatus 1000 determines a target cleaning region based on the obtained at least one position. In an embodiment, the electronic apparatus 1000 may determine an area within a preset range as a target cleaning region from any one position of the positions obtained in operation S310.

In an embodiment, the electronic apparatus 1000 may determine a region within a preset radius from the position of a position tracking tag device, as a target cleaning region. For example, the electronic apparatus 1000 may determine a region within a distance of 1 m or 2 m from the position of a position tracking tag device, as a target cleaning region.

In an embodiment, the electronic apparatus 1000 may determine an area within a preset range from the position of at least one home appliance, as a target cleaning region. In an embodiment, the electronic apparatus 1000 may obtain, from the robot cleaner 2000, not only the position information of at least one home appliance, but also device identification information of the at least one home appliance. The electronic apparatus 1000 may identify the type of at least one home appliance from the device identification information. The electronic apparatus 1000 may receive a user's input to select any one type of at least one type, identify the position of a home appliance corresponding to the type selected by the user's input, and determine a region within a preset radius from the identified position, as a target cleaning region.

In an embodiment, the electronic apparatus 1000 may photograph a region to be cleaned by using the camera 1300 (see FIG. 2), and identify the position of the region photographed by the camera 1300 based on the field of view (FOV) of the camera 1300 and the relative position information between the robot cleaner 2000 and the electronic apparatus 1000. The electronic apparatus 1000 may determine the identified region as a target cleaning region.

In operation S330, the electronic apparatus 1000 transmits information about the determined target cleaning region to the robot cleaner 2000. The electronic apparatus 1000 may transmit information about the target cleaning region to the robot cleaner 2000 by using at least one short-range wireless communication network of, for example, WiFi, WFD, Bluetooth, BLE, NFC, Zigbee, or μWave communication.

FIG. 4 is a diagram illustrating a method, performed by the electronic apparatus 1000 according to an embodiment of the present disclosure, of determining a target cleaning region of a robot cleaner based on the position of a position tracking tag device.

Referring to FIG. 4, the electronic apparatus 1000 may determine a target cleaning region 430 based on the position of the position tracking tag device 4000. The ‘position tracking tag device 4000’, as a portable tracker, is a device configured to provide position coordinates information to the electronic apparatus 1000. The position tracking tag device 4000 may be, for example, Galaxy Smart Tag™, but the present disclosure is not limited thereto.

In operation S410, the electronic apparatus 1000 may obtain the position information of the position tracking tag device 4000 from the position tracking tag device 4000. In an embodiment, the processor 1400 (see FIG. 2) of the electronic apparatus 1000 may be connected to the position tracking tag device 4000 through a BLE communication unit of the short-range wireless communication unit 1110 (see FIG. 2), and receive the position information of the position tracking tag device 4000 by using a BLE communication method.

However, the present disclosure is not limited thereto, and in another embodiment, the processor 1400 may obtain the position coordinates information of the position tracking tag device 4000 from a server through the short-range wireless communication unit 1110. In this case, the position tracking tag device 4000 may be a device that is preregistered on a server through the user account of the electronic apparatus 1000 and connected to the electronic apparatus 1000 through a server.

In an embodiment, the processor 1400 may identify the position of the position tracking tag device 4000 from the obtained position coordinates information of the position tracking tag device 4000, and determine a region within a preset radius from the identified position of the position tracking tag device 4000 as a target cleaning region. The processor 1400 may determine, for example, a region within a distance of 1 m or 2 m from the position of the position tracking tag device 4000, as a target cleaning region. A specific embodiment in which the processor 1400 determines a target cleaning region based on the position of the position tracking tag device 4000 is described in detail with reference to FIG. 4.

In operation S420, the electronic apparatus 1000 may determine the target cleaning region 430 based on the position of the position tracking tag device 4000. In an embodiment, the processor 1400 may identify the position of the position tracking tag device 4000 from the position information obtained through the short-range wireless communication unit 1110, and determine a region within a preset radius r from the identified position of the position tracking tag device 4000 as a target cleaning region. The processor 1400 may determine, for example, a region within the radius r of 1 m or 2 m from the position of the position tracking tag device 4000, as the target cleaning region 430.

In an embodiment, the electronic apparatus 1000 may display an indoor space map 400 through the display 1710, and display on the indoor space map 400 a position tracking tag device icon 410 representing the position of the position tracking tag device 4000 and a target cleaning region indicator 420 indicating the target cleaning region 430. The position tracking tag device icon 410 and the target cleaning region indicator 420 may be graphic UI.

In the embodiment illustrated in FIG. 4, the electronic apparatus 1000 may automatically set the target cleaning region 430 based on the position of the position tracking tag device 4000. Accordingly, according to an embodiment of the present disclosure, when a user wants to clean a specific region, without cumbersome and inconvenient works of directly selecting a specific region through an application, expanding or reducing the size of a region, and the like, by only placing the position tracking tag device 4000 at a desired place, the electronic apparatus 1000 automatically sets the target cleaning region 430 so that user convenience may be improved.

FIG. 5 is a diagram illustrating a method, performed by the electronic apparatus 1000 according to an embodiment of the present disclosure, of determining a target cleaning region of a robot cleaner based on the position information of the at least one home appliance 5000.

Referring to FIG. 5, the electronic apparatus 1000 may obtain the position information and device identification information of the at least one home appliance 5000 located in the indoor space from the robot cleaner 2000, and determine a target cleaning region based on the obtained position information and device identification information of the at least one home appliance 5000. Although FIG. 5 illustrates that the at least one home appliance 5000 comprises a plurality of home appliances including a first home appliance 5001 to a third home appliance 5003, this is an example, and the present disclosure is not limited thereto. In an embodiment, only one home appliance may be located in the indoor space

In operation S510, the robot cleaner 2000 obtains the position and device identification information of the first home appliance 5001. In an embodiment, the robot cleaner 2000 may include a short-range wireless communication unit to perform short-range wireless communication with the at least one home appliance 5000. The robot cleaner 2000 may receive a signal from the at least one home appliance 5000 through at least one short-range wireless communication network of, for example, WiFi, WFD, Bluetooth, BLE, NFC, Zigbee, or μWave communication. The robot cleaner 2000 may estimate the position of the first home appliance 5001 based on the RSSI of a signal received from the first home appliance 5001 by using the short-range wireless communication unit. The received signal may include the device identification information of the first home appliance 5001. The device identification information may include, for example, a device id.

The robot cleaner 2000, while moving within the indoor space, may estimate the positions of a second home appliance 5002 and the third home appliance 5003 based on the strength of signals received from the second home appliance 5002 and the third home appliance 5003. The robot cleaner 2000 may receive the device identification information of the second home appliance 5002 and the third home appliance 5003.

However, the present disclosure is not limited thereto, and the robot cleaner 2000 may estimate the position of the at least one home appliance 5000, by analyzing image information obtained through a camera. In this case, the robot cleaner 2000 may estimate the position of each of the at least one home appliance 5000 by applying image information to an artificial intelligence model trained to recognize an object. For example, when the robot cleaner 2000 inputs a living room image obtained through a camera to an artificial intelligence model, the robot cleaner 2000 may receive, as a result value, information that an air conditioner living that is the second home appliance 5002 is located to the left of a room from the artificial intelligence model, a TV that is the first home appliance 5001 is located at the center of the living room, and a refrigerator that is the third home appliance 5003 is located to the right of the living room information. The robot cleaner 2000 may generate an indoor space map representing the position of each of the at least one home appliance 5000 based on a result value of the artificial intelligence model.

In operation S520, the electronic apparatus 1000 receives the position and device identification information of the at least one home appliance 5000 from the robot cleaner 2000. In an embodiment, the processor 1400 (see FIG. 2) of the electronic apparatus 1000 may receive the position and device identification information of the at least one home appliance 5000 from the robot cleaner 2000 by using at least one short-range wireless communication network of WiFi, WFD, Bluetooth, BLE, NFC, Zigbee, or μWave communication.

The electronic apparatus 1000 may identify the device type of each of the at least one home appliance 5000 based on the received device identification information of the at least one home appliance 5000. In an embodiment, the processor 1400 of the electronic apparatus 1000 may identify the device type of the at least one home appliance 5000, by using device identification information and device type matching information stored in the memory 1500 (see FIG. 2). However, the present disclosure is not limited thereto, and the processor 1400 may transmit the device identification information of the at least one home appliance 5000 to a server, and from a server device type information according to device identification information, by using the communication interface 1100 (see FIG. 2). The processor 1400 may identify the device type of each of the at least one home appliance 5000 from a server based on the received device type information.

The electronic apparatus 1000 may display an indoor space map 500, and display UIs 511 to 513 representing the position and device type of each of the at least one home appliance 5000 identified on the indoor space map 500. In an embodiment, the processor 1400 may control the display 1710 to display, on the indoor space map 500, the first UI 511 representing the position and device type of the first home appliance 5001, the second UI 512 representing the position and device type of the second home appliance 5002, and the third UI 513 representing the position and device type of the third home appliance 5003. In the embodiment illustrated in FIG. 5, the first UI 511, the second UI 512, and the third UI 513 are respectively illustrated with UIs in text of ‘TV’, ‘air conditioner’, and ‘refrigerator’, but the present disclosure is not limited thereto. In another embodiment, the first UI 511 to the third UI 513 may be implemented by a graphic UI (GUI) representing a TV, an air conditioner, and a refrigerator as an image or icon.

The electronic apparatus 1000 may receive a user's input to select any one of the UIs 511 to 513. In an embodiment, the processor 1400 may receive a user's touch input to select any one of the first UI 511 to the third UI 513 displayed on the display 1710 through the user's input interface 1610.

However, the present disclosure is not limited thereto, and in another embodiment, the processor 1400 may receive a voice input to utter the device type of a home appliance from a user through the microphone 1620. For example, the microphone 1620 may receive a voice input “Please set the area around the TV as a cleaning region” from a user.

The electronic apparatus 1000 may identify a home appliance corresponding to the device type selected based on the user's input, from among the at least one home appliance 5000, and determine an area within a preset range from the identified position of the home appliance as a target cleaning region. In the embodiment illustrated in FIG. 5, when the first UI 511 is selected through the user's input, the processor 1400 may identify a TV of the selected device type, and identify the first home appliance 5001 that is a TV, among the at least one home appliance 5000. The processor 1400 may determine a region within a preset radius from the first home appliance 5001 as a target cleaning region. The processor 1400 may determine, for example, a region within a radius of 1 m or 2 m from the TV that is the first home appliance 5001, as a target cleaning region.

In operation S530, the electronic apparatus 1000 transmits information about the target cleaning region to the robot cleaner 2000. In an embodiment, the processor 1400 may transmit information about the target cleaning region to the robot cleaner 2000 through the short-range wireless communication unit 1110.

FIG. 6 is a flowchart of a method, performed by the electronic apparatus 1000 according to an embodiment of the present disclosure, of determining a target cleaning region of the robot cleaner 2000 based on the position information of the home appliance 5000.

In operation S610, the robot cleaner 2000 transmits a signal requesting the device identification information of the home appliance 5000 to the home appliance 5000. In an embodiment, while moving in the indoor space, the robot cleaner 2000 may transmit a query signal requesting device identification information to the home appliance 5000. In an embodiment, the device identification information may include information about the device id of the home appliance 5000.

In operation S620, the robot cleaner 2000 receives device identification information from the home appliance 5000. In an embodiment, the robot cleaner 2000 may include a short-range wireless communication unit that receives a signal from the at least one home appliance 5000 through at least one short-range wireless communication network of WiFi, WFD, Bluetooth, BLE, NFC, Zigbee, or μWave communication. The robot cleaner 2000 may receive the device identification information from the home appliance 5000 by using a short-range wireless communication unit.

In operation S630, the robot cleaner 2000 obtains the position and device identification information of a home appliance. In an embodiment, while moving in the indoor space, the robot cleaner 2000 may estimate the position of a home appliance based on the RSSI of a signal received from the home appliance 5000.

However, the present disclosure is not limited thereto, and in another embodiment, the robot cleaner 2000 may estimate the position of the home appliance 5000 by analyzing image information obtained through a camera. In this case, the robot cleaner 2000 may estimate the position of each home appliance 5000 by applying the image information to an artificial intelligence model that is trained to recognize an object.

In operation S640, the robot cleaner 2000 transmits the position information and device identification information of the home appliance 5000 to the electronic apparatus 1000. In an embodiment, the robot cleaner 2000 may transmit the position information and device identification information of the home appliance 5000 to the electronic apparatus 1000, through at least one short-range wireless communication network of WiFi, WFD, Bluetooth, BLE, NFC, Zigbee, or μWave communication.

In operation S650, the electronic apparatus 1000 identifies the type of the home appliance 5000 from the device identification information. In an embodiment, the electronic apparatus 1000 may identify the device type of the home appliance 5000 by using the device identification information and the device type matching information stored in the memory 1500 (see FIG. 2). However, the present disclosure is not limited thereto, and the electronic apparatus 1000 may transmit the device identification information of the home appliance 5000 to a server by using the communication interface 1100 (see FIG. 2), and receive information about a device type according to the device identification information from a server. The electronic apparatus 1000 may identify the device type of the home appliance 5000 from a server based on the received device type information.

In operation S660, the electronic apparatus 1000 displays a UI representing the type and position of the home appliance 5000. In an embodiment, the electronic apparatus 1000 may display, on the indoor space map, the UI representing the type and position of the home appliance 5000. For example, the electronic apparatus 1000 may display, on the indoor space map, an icon that visually represents the type and position of the home appliance 5000. However, the present disclosure is not limited thereto, and in another embodiment, the electronic apparatus 1000 may display a UI representing the type of the home appliance 5000 in text.

In operation S670, the electronic apparatus 1000 receives a user's input to select the type of a home appliance from among displayed UIs. In an embodiment, the electronic apparatus 1000 may receive a user's touch input to select any one of types represented by the UIs.

In another embodiment, the processor 1400 may receive a voice input to utter the device type of a home appliance from a user through the microphone 1620. In this case, the processor 1400 may receive a voice input from a user regarding not only the device type of a home appliance, but also the position where the home appliance is located. For example, the processor 1400 may receive a voice input “Please clean the area around the TV in the master bedroom” through the microphone 1620.

In operation S680, the electronic apparatus 1000 determines a region within a preset radius from the position of the home appliance 5000 corresponding to the type selected based on the user's input, as a target cleaning region.

In operation S690, the electronic apparatus 1000 transmits information about the target cleaning region to the robot cleaner 2000.

FIGS. 5 and 6 illustrate the embodiment in which the electronic apparatus 1000 determines a target cleaning region through edge computing of transceiving data with the robot cleaner 2000, without intervention of an external server, by using at least one short-range wireless communication network of WiFi, WFD, Bluetooth, BLE, NFC, Zigbee, or μWave communication. As the electronic apparatus 1000 determines a target cleaning region through edge computing without intervention of an external server, the technical effects of preventing the generation of a network cost and reducing latency are provided.

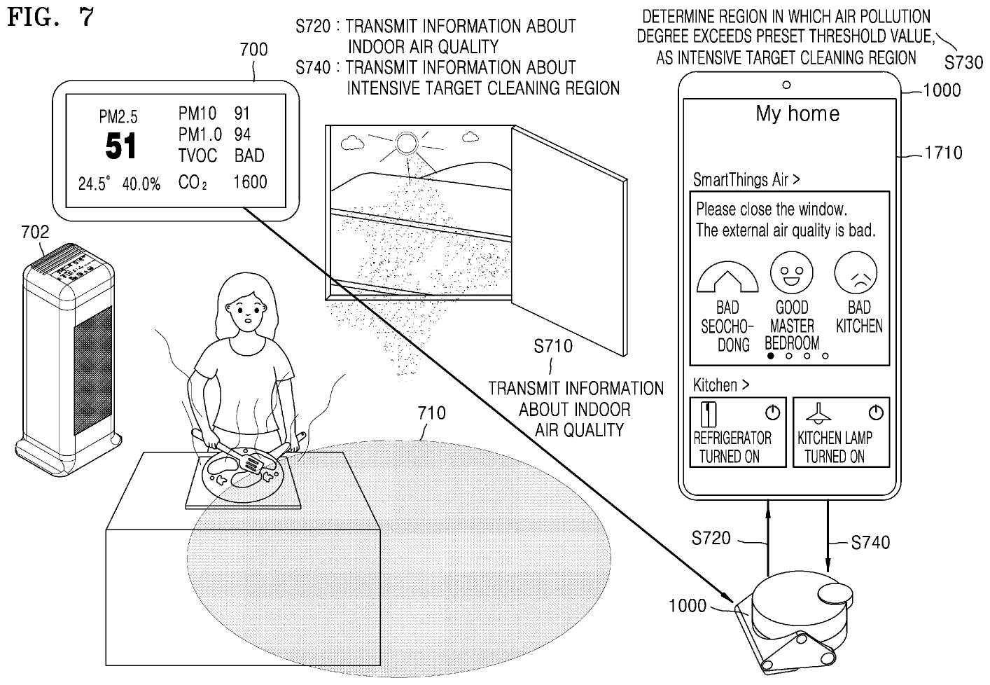

FIG. 7 is a diagram illustrating a method, performed by the electronic apparatus 1000 according to an embodiment of the present disclosure, of determining an intensive target cleaning region based on information about the air quality of an indoor space.

Referring to FIG. 7, an air quality measurement device 700 or an air purifier 702 may measure indoor air quality, and transmit information about the indoor air quality to the robot cleaner 2000.

The air quality measurement device 700 is a device for sensing the quality of indoor air and providing air quality state information. In an embodiment, the air quality measurement device 700 may measure an air pollution index including at least one of Particulate Matter 10 (PM10), Particulate Matter 2.5 (PM2.5), Particulate Matter 1.0 (PM1.0), or Total Volatile Organic Compounds (TVOC). In an embodiment, the air quality measurement device 700 may include at least one sensor of a temperature sensor, a humidity sensor, a fine dust sensor, a TVOC sensor, a CO₂ sensor, and a radon sensor. The air quality measurement device 700 may include, for example, Samsung Airmonitor™, but the present disclosure is not limited thereto.

In operation S710, the robot cleaner 2000 receives information about the indoor air quality from the air quality measurement device 700 or the air purifier 702. The robot cleaner 2000, while moving in the indoor space along a traveling path, may receive air quality information for each region of the indoor space. The information about the indoor air quality may include information about at least one of air pollution indexed including PM10, PM2.5, PM1.0, and TVOC for each region of the indoor space.

In an embodiment, the robot cleaner 2000 may include a short-range wireless communication unit, and receive information about the indoor air quality from the air quality measurement device 700 or the air purifier 702, through at least one short-range wireless communication network of WiFi, WFD, Bluetooth, BLE, NFC, Zigbee, or μWave communication.

In operation S720, the robot cleaner 2000 transmits information about the indoor air quality to the electronic apparatus 1000. In an embodiment, the robot cleaner 2000 may transmit the information about the indoor air quality received from the air quality measurement device 700 or the air purifier 702, to the electronic apparatus 1000, by using a short-range wireless communication unit.

In operation S730, the electronic apparatus 1000 determines an area in which an air pollution degree exceeds a preset threshold value, as an intensive target cleaning region 710. In an embodiment, the processor 1400 (see FIG. 2) of the electronic apparatus 1000 may receive information about the air quality for each region of the indoor space from the robot cleaner 2000 by using the short-range wireless communication unit 1110 (see FIG. 2), and identify an air pollution degree from the received information about the air quality for each region. The processor 1400 may compare the air pollution degree with a preset threshold value, and identify a region that exceeds the threshold value. For example, when a PM2.5 value exceeds 50 that is a threshold value for PM2.5, the processor 1400 may identify the region to be a region with a high air pollution degree.

The processor 1400 may determine the identified region as the intensive target cleaning region 710. In an embodiment, the intensive target cleaning region 710 may be a partial area of a predetermined target cleaning region. However, the present disclosure is not limited thereto, and the processor 1400 may determine the region that is identified as a region with a high air pollution degree, as a target cleaning region.

In operation S740, the electronic apparatus 1000 transmits information about an intensive target cleaning region to the robot cleaner 2000. In an embodiment, the processor 1400 may transmit information about an intensive target cleaning region to the robot cleaner 2000 by using the short-range wireless communication unit 1110 (see FIG. 2).

FIG. 8A is a diagram illustrating a method, performed by the electronic apparatus 1000 according to an embodiment of the present disclosure, of obtaining relative position information between the robot cleaner 2000 and the electronic apparatus 1000.

Referring to FIG. 8A, the robot cleaner 2000 may obtain position information in indoor space, and transmit the position information to the electronic apparatus 1000. In an embodiment, the robot cleaner 2000 may include at least one sensor of an ultrasound sensor, an infrared sensor, or a light detection and ranging (LiDAR) sensor, search the indoor space using the at least one sensor, and generate an indoor space map. The indoor space refers to an area in which the robot cleaner 2000 substantially freely move. The ‘indoor space map’ may include data of at least one of, for example, a navigation map used for traveling during cleaning, a simultaneous localization and mapping (SLAM) map used for recognizing a position, and an obstacle recognition map where information about recognized obstacles is recorded. In an embodiment, the robot cleaner 2000 may identify the position of the robot cleaner 2000 on the indoor space map by using SLAM technology. The robot cleaner 2000 may transmit information about the identified position to the electronic apparatus 1000.

The electronic apparatus 1000 may receive the position information of the robot cleaner 2000 from the robot cleaner 2000. The processor 1400 of the electronic apparatus 1000 (see FIG. 2) may receive the position information from the robot cleaner 2000 by using the UWB communication module 1120 (see FIG. 2). The processor 1400 may receive indoor space map data from the robot cleaner 2000 by using the UWB communication module 1120.

The electronic apparatus 1000 may display an indoor space map 800, an icon 810 representing the position of the electronic apparatus 1000, and an icon 820 representing the position of the robot cleaner 2000, on the display 1710, by using the position information of the robot cleaner 2000 and the indoor space map data received from the robot cleaner 2000.

The electronic apparatus 1000 may obtain the relative position information between the robot cleaner 2000 and the electronic apparatus 1000, based on at least one of the position, height, direction, and inclination angle of the electronic apparatus 1000. The ‘relative position between the robot cleaner 2000 and the electronic apparatus 1000’ may refer to the position information of the robot cleaner 2000 with respect to the position of the electronic apparatus 1000. The relative position information between the robot cleaner 2000 and the electronic apparatus 1000 may include the information about a distance from the electronic apparatus 1000 to the robot cleaner 2000 and the information about an angle formed between the electronic apparatus 1000 and the robot cleaner 2000.

In an embodiment, the processor 1400 may obtain the information about the direction of the electronic apparatus 1000 by using the geomagnetic sensor 1210 (see FIG. 2), and the information about the inclination angle of the electronic apparatus 1000 by using the gyro sensor 1220 and the acceleration sensor 1230. The processor 1400 may obtain the relative position information between the robot cleaner 2000 and the electronic apparatus 1000 based on the position information of the robot cleaner 2000 and the information about the direction and inclination angle of the electronic apparatus 1000.

In an embodiment, the processor 1400 may control the display 1710 to display the UI 810 representing the position of the electronic apparatus 1000 on the indoor space map 800.

FIG. 8B is a diagram illustrating a method, performed by the electronic apparatus 1000 according to an embodiment of the present disclosure, of photographing a region to be cleaned and displaying the photographed region

Referring to FIG. 8B, the electronic apparatus 1000 may include the camera 1300 (see FIG. 2), and obtain an image by photographing a region to be cleaned in the indoor space by using the camera 1300. The position of a region photographed by using camera 1300 may be determined to be different depending on the direction in which the electronic apparatus 1000 faces, an inclination angle, and the field of view (FOV) of the camera 1300. The ‘FOV of the camera 1300’ refers to an angle representing the size of a region to be observed through a lens of the camera 1300 and photographed. The FOV of the camera 1300 may be determined depending on the position and direction in which the lens of the camera 1300 is arranged, and the direction and inclination angle of the electronic apparatus 1000.

FIG. 8C is a diagram illustrating a method, performed by the electronic apparatus 1000 according to an embodiment of the present disclosure, of determining a target cleaning region based on the relative position information with respect to the robot cleaner 2000 and the field of view (FOV) of the camera.

Referring to FIG. 8C, the electronic apparatus 1000 may determine a target cleaning region 830 based on the relative position with respect to the robot cleaner 2000 and the FOV of the camera 1300 (see FIG. 8B).

In an embodiment, the relative position between the robot cleaner 2000 and the electronic apparatus 1000 refers to the position information of the robot cleaner 2000 with respect to the position of the electronic apparatus 1000. The relative position information between the robot cleaner 2000 and the electronic apparatus 1000 may include information about a separation distance d between the electronic apparatus 1000 and the robot cleaner 2000 and an angle α formed between the electronic apparatus 1000 and the robot cleaner 2000.

In the embodiment illustrated in FIG. 8C, the electronic apparatus 1000 may be inclined by the angle α with respect to the X-axis direction, separated from the bottom surface by a height h in the Z-axis direction, and placed in a direction opposite to the direction facing the robot cleaner 2000. The processor 1400 of the electronic apparatus 1000 (see FIG. 2) may obtain information about a direction (ori) in which the electronic apparatus 1000 is placed by measuring the azimuth of the electronic apparatus 1000 using the geomagnetic sensor 1210 (see FIG. 2). The processor 1400 may obtain a value of the angle α of inclination with respect to the X-axis by measuring, by the electronic apparatus 1000, an inclination angle by using the gyro sensor 1220 (see FIG. 2) and the acceleration sensor 1230 (see FIG. 2).

The processor 1400 may identify the position of the region photographed by the camera 1300 based on the relative position between the robot cleaner 2000 and the electronic apparatus 1000, the direction (ori) information and inclination angle α information of the electronic apparatus 1000, and the FOV of the camera 1300. In the embodiment illustrated in FIG. 8C, as the photograph region forms an angle of a (90°-α) size with the X-axis and is apart from the bottom surface by the height h, the processor 1400 may estimate the position of the photographed region by using a trigonometric function calculation method. As the position of a photographed region may vary according to the FOV for photographing through the lens of the camera 1300, the processor 1400 may identify the position of a photographed region by correcting the region estimated through the trigonometric function by using FOV information.

The processor 1400 may determine the finally identified region as a target cleaning region. The processor 1400 may transmit information about a target cleaning region to the robot cleaner 2000 by using the short-range wireless communication unit 1110 (see FIG. 2).

FIG. 9 is a flowchart of a method, performed by the electronic apparatus 1000 according to an embodiment of the present disclosure, of determining a target cleaning region based on a relative positional relationship with the robot cleaner 2000 and the FOV of a camera.

Operations S910 to S930 among the operations illustrated in FIG. 9 are operations obtained by specifying operation S310 illustrated in FIG. 3. S940 to S960 among the operations illustrated in FIG. 9 are operations obtained by specifying operation S320 illustrated in FIG. 3. After operation S960 is performed, operation S330 illustrated in FIG. 3 may be performed.

In operation S910, the electronic apparatus 1000 receives the position information of the robot cleaner 2000 by using an UWB communication network. In an embodiment, the electronic apparatus 1000 may receive position information from the robot cleaner 2000 by using the UWB communication module 1120 (see FIG. 2). The UWB communication module 1120 is a communication module performing data transceiving by using UWB frequency range between 3.1 GHz to 10.6 GHz. The UWB communication module 1120 may transceive data at a maximum speed of 500 Mbps.

In operation S920, the electronic apparatus 1000 measures the direction and inclination angle of the electronic apparatus 1000. In an embodiment, the electronic apparatus 1000 may measure the azimuth of the electronic apparatus 1000 by using the geomagnetic sensor 1210 (see FIG. 2), and direction information of the electronic apparatus 1000 based on the measured azimuth. In an embodiment, the electronic apparatus 1000 may obtain the information about the inclination angle of the electronic apparatus 1000 by using the gyro sensor 1220 (see FIG. 2) and the acceleration sensor 1230 (see FIG. 2).

In operation S930, the electronic apparatus 1000 obtains the relative position information between the robot cleaner 2000 and the electronic apparatus 1000 based on the position of the robot cleaner 2000 and the direction and inclination angle of the electronic apparatus 1000. The ‘relative position between the robot cleaner 2000 and the electronic apparatus 1000’ may refer to the position information of the robot cleaner 2000 with respect to the position of the electronic apparatus 1000. The relative position information between the robot cleaner 2000 and the electronic apparatus 1000 may include the information about a distance from the electronic apparatus 1000 to the robot cleaner 2000 and the information about an angle formed between the electronic apparatus 1000 and the robot cleaner 2000.

In operation S940, the electronic apparatus 1000 photographs a region to be cleaned by using the camera 1300 (see FIG. 2).

In operation S950, the electronic apparatus 1000 identifies a photographed region based on the field of view (FOV) of the camera 1300 and the relative position information between the electronic apparatus 1000 and the robot cleaner 2000. In an embodiment, the electronic apparatus 1000 may estimate the position of a photographed region through a trigonometric function algorithm by using information about a separation distance from the robot cleaner 2000, an angle formed between the robot cleaner 2000 and the electronic apparatus 1000, and a height value of the electronic apparatus 1000 from the bottom surface. In an embodiment, the electronic apparatus 1000 may identify the position of a photographed region by correcting the estimated position of a photographed region by using the FOV information of the camera 1300.

In operation S960, the electronic apparatus 1000 determines the identified region as a target cleaning region.

In the embodiments illustrated in FIGS. 8A to 8C and 9, the electronic apparatus 1000 may receive the position information of the robot cleaner 2000 through an UWB communication network, and automatically determine the region photographed through the camera 1300 as a target cleaning region, based on the direction and inclination angle of the electronic apparatus 1000 and the FOV of the camera 1300. The electronic apparatus 1000 according to an embodiment of the present disclosure may obtain accurate position information of the robot cleaner 2000 and the electronic apparatus 1000 by using an UWB communication network. Furthermore, when a user wants to clean a specific region, the electronic apparatus 1000 according to an embodiment of the present disclosure directly selects the specific region through an application and automatically determines the region photographed through the camera 1300 as a target cleaning region, without cumbersome and inconvenient works of directly selecting a specific region through an application, expanding or reducing the size of a region, and the like, thereby improving user convenience.

FIG. 10 is a diagram illustrating a method, performed by the electronic apparatus 1000 according to an embodiment of the present disclosure, of controlling the robot cleaner 2000 to perform a cleaning operation on a target cleaning region based on a voice input received from a user.

Referring to FIG. 10, in operation S1010, the electronic apparatus 1000 receives a voice input including a cleaning command for a target cleaning region from a user through the microphone 1620 (see FIG. 2). The ‘voice input’ may be a voice uttered by a user. In an embodiment, the voice input may include a wake up voice. The ‘wake up voice’ is a signal to switch the electronic apparatus 1000 from a standby mode to a voice recognition function mode, and may include, for example, ‘high Bixby,’‘OK Google,’ or the like.

The voice input may include information to specify a target cleaning region. In an embodiment, the voice input may include the type of a home appliance located around the position tracking tag device 4000 (see FIG. 4) or the robot cleaner 2000. For example, the voice input may include information about the position tracking tag device 4000 or the type of a home appliance, such as “Please clean the area around the smart tag” or “Please clean the area around the TV.” In the embodiment illustrated in FIG. 10, the electronic apparatus 1000 may receive a voice input such as “Hi Bixby! Please clean the area around the TV with Powerbot” through the microphone 1620.

In an embodiment, the microphone 1620 may convert the received voice input into a sound signal and remove noise (e.g., a non-voice component) from the sound signal, thereby obtaining a voice signal.

In operation S1020, the electronic apparatus 1000 transmits data of the voice input to a server 3000. In an embodiment, the processor 1400 (see FIG. 2) of the electronic apparatus 1000 may transmit the voice signal obtained from the microphone 1620 to the server 3000. In an embodiment, the processor 1400 may transmit the voice signal to the server 3000 by using the communication interface 1100 (see FIG. 2).

The server 3000 may have a natural language processing ability to recognize user's intent and parameters included in the voice signal, by interpreting the voice signal. In an embodiment, the server 3000 may convert the voice signal received from the electronic apparatus 1000 into a computer-readable text, and interpret the text by using a natural language understanding model, thereby obtaining intent and parameter information. Here, the ‘intent,’ which is information indicating the user's utterance intent, may be information indicating the operation of an operation performing device requested by a user. For example, in the text “Please clean the area around the TV with Powerbot,” the intent may be a ‘cleaning command.’ The ‘parameter’ refers to variable information to determine specific operations of an operation performing device related to the intent. For example, in the text “Please clean the area around the TV with Powerbot,” the parameters may be the name of an operation performing device, that is, ‘Powerbot’, and a target cleaning region, that is, ‘around the TV.’

In operation S1030, the server 3000 may transmit a natural language interpretation result of the voice input to the electronic apparatus 1000. The natural language interpretation result may include intent and parameter information obtained by interpreting the text converted from the voice signal. In the embodiment illustrated in FIG. 10, the server 3000 may transmit information about the intent of ‘cleaning command’ and parameters of ‘Powerbot’ and ‘around the TV’ to the electronic apparatus 1000.

In operation S1040, the electronic apparatus 1000 obtains a cleaning command and information about a target cleaning region from the received natural language interpretation result. The processor 1400 of the electronic apparatus 1000 may identify a cleaning command from the intent and information about a target cleaning region from the parameter. For example, the processor 1400 may identify the robot cleaner 2000 from the parameter of ‘Powerbot’, and determine the robot cleaner 2000 as an operation performing device.

In an embodiment, the processor 1400 may obtain information about the position tracking tag device 4000 or the type of a home appliance to specify a target cleaning region from the parameter information. For example, when a voice input received from a user is “Please clean the area around the smart tag,” the processor 1400 may obtain the position tracking tag device as information to determine a target cleaning region, from the parameter information received from the server 3000. In another example, when the voice input is “Please clean the area around the TV,” the processor 1400 may obtain the type of a home appliance (e.g., TV) as information to determine a target cleaning region, from the parameter information received from the server 3000.

The electronic apparatus 1000 may generate a control command to control the robot cleaner 2000 that is an operation performing device. The ‘control command’ refers to instructions that are readable and executable by an operation performing device so that the operation performing device (the robot cleaner 2000 in the embodiment illustrated in FIG. 10) can perform detailed operations included in operation information. In an embodiment, the control command may further include not only position information about a target cleaning region, but also at least one of a cleaning command for a target cleaning region, a return command to a charging station, a direction change command, or a command to perform cleaning in a specific operation mode (e.g., an intensive mode, a general mode, or a repetition mode).

In operation S1050, the electronic apparatus 1000 transmits the control command to the robot cleaner 2000. In an embodiment, the electronic apparatus 1000 may transmit the control command to the robot cleaner 2000 through at least one short-range wireless communication network of WiFi, WFD, Bluetooth, BLE, NFC, Zigbee, or μWave communication.

In operation S1060, the robot cleaner 2000 performs a cleaning operation according to the control command. In the embodiment illustrated in FIG. 10, the control command may include detailed pieces of information to perform a cleaning operation for a target cleaning region of ‘around the TV’. The robot cleaner 2000 may plan a cleaning path for an area within a preset range from the TV according to the control command, and complete the cleaning operation according to the planned cleaning path. When the robot cleaner 2000 recognized an obstacle around the TV during cleaning, the robot cleaner 2000 may change the planned cleaning path, or stop cleaning the area around the TV. For example, when the obstacle is not large, the robot cleaner 2000 may change the cleaning path by cleaning to avoid the obstacle, and when the obstacle is too big so that cleaning cannot proceed any further, the robot cleaner 2000 may stop cleaning and return to a charging station.

FIG. 11 is a flowchart of a method, performed by the electronic apparatus 1000 according to an embodiment of the present disclosure, of controlling the robot cleaner 2000 to perform a cleaning operation on a target cleaning region.

The operations illustrated in FIG. 11 are performed after the operation S330 illustrated in FIG. 3 is performed. Operation S1110 illustrated in FIG. 11 may be performed after the operation S330 of FIG. 3 is performed.

In operation S1110, the electronic apparatus 1000 receives a voice input from a user. In an embodiment, the electronic apparatus 1000 may receive a voice input including a cleaning command for a target cleaning region, from a user, through the microphone 1620 (see FIG. 2). The ‘voice input’ may be a voice uttered by a user.

In operation S1120, the electronic apparatus 1000 transmits voice signal data to the server 3000. In an embodiment, the microphone 1620 of the electronic apparatus 1000 may convert the received voice input into a sound signal and remove noise (e.g., a non-voice component) from the sound signal, thereby obtaining a voice signal. The electronic apparatus 1000 may transmit the voice signal data to the server 3000.

In operation S1130, the server 3000 converts the voice signal data into text. In an embodiment, the server 3000 may convert the voice signal into a computer-readable text by performing automatic speech recognition (ASR) by using an ASR model.

Although FIG. 11 illustrates that the electronic apparatus 1000 transmits the voice signal data to the server 3000 and the server 3000 performs ASR, the embodiment of the present disclosure is not limited to the illustration of FIG. 11. In another embodiment, the electronic apparatus 1000 includes an ASR model, and the processor 1400 (see FIG. 2) of the electronic apparatus 1000 performs ASR by using the ASR model, thereby converting the voice signal into text. The processor 1400 may transmit the text to the server 3000 through the communication interface 1100 (see FIG. 2).

In operation S1140, the server 3000 interprets the text by using a natural language understanding model, thereby recognizing the user's intent and parameters. In an embodiment, the intent may be a ‘cleaning command’, and the parameter may be ‘information to specify a target cleaning region’. The parameter information may include, for example, information about the position tracking tag device or the type of a home appliance around the robot cleaner 2000. As the descriptions of intent and parameter are the same as those presented in FIG. 10, redundant descriptions thereof are omitted.

In operation S1150, the server 3000 transmits the intent and parameter information to the electronic apparatus 1000.

In operation S1160, the electronic apparatus 1000 identify a cleaning command and a target cleaning region from the intent and parameter information. The target cleaning region may be identified from the parameter information. For example, when a voice input received from a user is “Please clean the area around the smart tag,” the electronic apparatus 1000 may identify an area within a preset range from a position tracking tag device, as a target cleaning region, from the parameter information received from the server 3000. In another example, when a voice input is “Please clean the area around the TV,” the electronic apparatus 1000 may identify an area within a preset range from a home appliance corresponding to the type of a home appliance (e.g., TV) from the parameter information received from the server 3000, as a target cleaning region.

In operation S1170, the electronic apparatus 1000 generates a control command to control the robot cleaner 2000 to perform a cleaning operation on the target cleaning region. The ‘control command’ refers to instructions that are readable and executable by the robot cleaner 2000 so that the robot cleaner 2000 can perform detailed operations included in operation information for a cleaning operation as the control command is the same as that described in FIG. 10, a redundant description thereof is omitted.

In operation S1180, the electronic apparatus 1000 transmits the control command to the robot cleaner 2000.

In operation S1190, the robot cleaner 2000 performs a cleaning operation on the target cleaning region according to the control command.

An electronic apparatus according to an embodiment of the present disclosure may include a communication interface configured to perform data transceiving by using a wireless communication network, a memory storing at least one instruction, and at least one processor configured to execute the at least one instruction. In an embodiment of the present disclosure, the at least one processor may obtain position information about at least one of a position of a position tracking tag device, a position of at least one home appliance located around the robot cleaner, and a relative position between the robot cleaner and the electronic apparatus, by using the communication interface. In an embodiment of the present disclosure, the at least one processor may determine a target cleaning region based on the obtained at least one position information. In an embodiment of the present disclosure, the at least one processor may control the communication interface to transmit information about the determined target cleaning region to the robot cleaner.

In an embodiment of the present disclosure, the at least one processor may determine a region within a preset radius as the target cleaning region based on the obtained position information of the position tracking tag device.

In an embodiment of the present disclosure, the robot cleaner may include a short-range wireless communication module that wirelessly performs data transceiving, and the position information of at least one home appliance may be obtained by the robot cleaner from the at least one home appliance by using the short-range wireless communication module.

In an embodiment of the present disclosure, the electronic apparatus may further include a display, wherein the at least one processor may receive device identification information of the at least one home appliance from the robot cleaner by using the communication interface, and identify a type of the at least one home appliance based on the received device identification information, and control the display to display a user interface (UI) representing the type and position of the at least one home appliance.

In an embodiment of the present disclosure, the electronic apparatus may further include a user's input portion for receiving a user's input to select any one type of the type of at least one home appliance through the UI, and the at least one processor may identify the position of a home appliance corresponding to the elected selected based on the received user's input, and determine an area within a preset radius from the identified position of the home appliance preset as the target cleaning region.

In an embodiment of the present disclosure, the at least one processor may obtain information about air quality of an indoor space from the robot cleaner by using the communication interface, and determine an area in which an air pollution degree exceeds a preset threshold value of the determined target cleaning region, as an intensive target cleaning region, based on the obtained information about air quality.

In an embodiment of the present disclosure, the electronic apparatus may further include a geomagnetic sensor for measuring an azimuth of the electronic apparatus, and a gyro sensor and an acceleration sensor for measuring a rotation angle or an inclination angle of the electronic apparatus, and the at least one processor may obtain information about a height and direction of the electronic apparatus from the azimuth measured by using the geomagnetic sensor, and obtain information about the inclination angle of the electronic apparatus by using the gyro sensor and the acceleration sensor, and obtain information about the relative position between the robot cleaner and the electronic apparatus by using the position information of the robot cleaner received by using an ultra wide band (UWB) and the electronic apparatus position information including at least one of the height, direction, and inclination angle of the electronic apparatus.

In an embodiment of the present disclosure, the electronic apparatus may further include a camera for photographing a region to be cleaned by a user, and the at least one processor may identify a region photographed by the camera based on the field of view (FOV) of a camera and the relative position information of the electronic apparatus and the robot cleaner, and determine the identified region as the target cleaning region.

In an embodiment of the present disclosure, the electronic apparatus may further include a display portion, and the at least one processor may control the display portion to display a UI representing the determined target cleaning region on a map that visually shows an indoor space.

In an embodiment of the present disclosure, the electronic apparatus may further include a microphone for receiving a voice input including a cleaning command for the determined target cleaning region, and the at least one processor may identify the cleaning command from the voice input based on a result of interpreting the voice input by using a natural language understanding model, and generate a control command to control an operation of the robot cleaner from the identified cleaning command, and control the communication interface to transmit the control command to the robot cleaner.

In an embodiment of the present disclosure, the at least one processor may transmit data about the voice input to a server by using the communication interface, receive, from the server, information about the type of a home appliance or the position tracking tag device identified from the voice input according to an interpretation result of the voice input by the server, and generate a control command to control a cleaning operation for target cleaning region determined according to the position tracking tag device or the type of a home appliance.

In an embodiment of the present disclosure, a method of controlling a robot cleaner may include obtaining information about at least one of a position of a position tracking tag device, a position of at least one home appliance located around the robot cleaner, and a relative position between the robot cleaner and the electronic apparatus, by using a wireless communication network. In an embodiment of the present disclosure, the method of controlling a robot cleaner may include determining a target cleaning region based on the obtained at least one of position information. In an embodiment of the present disclosure, the method of controlling a robot cleaner may include transmitting the determined information about a target cleaning region to the robot cleaner.

In an embodiment of the present disclosure, in the determining of the target cleaning region, the electronic apparatus may determine a region within a preset radius as the target cleaning region based on the obtained position information of the position tracking tag device.

In an embodiment of the present disclosure, the robot cleaner may include a short-range wireless communication module that wirelessly performs data transceiving, and the position information of at least one home appliance may be obtained by the robot cleaner from the at least one home appliance by using the short-range wireless communication module.

In an embodiment of the present disclosure, the method may further include receiving device identification information of the at least one home appliance from the robot cleaner, identifying a type of the at least one home appliance based on the received device identification information, and displaying a user interface UI representing the type and position of the at least one home appliance.

In an embodiment of the present disclosure, the determining of the target cleaning region may include receiving a user's input to select any one of the type of at least one home appliance through the UI, and identifying the position of a home appliance corresponding to the type selected based on the received user's input, and determining an area within a preset radius from the identified position of the home appliance as the target cleaning region.

In an embodiment of the present disclosure, the determining of the target cleaning region may include photographing a region to be cleaned by a user by using a camera, identifying a region photographed by the camera based on the field of view (FOV) of a camera and the relative position information of the electronic apparatus and the robot cleaner, and determining the identified region as the target cleaning region.

In an embodiment of the present disclosure, the method may further include displaying a UI representing the determined target cleaning region on a map that visually shows an indoor space.

In an embodiment of the present disclosure, the method may further include receiving a voice input including a cleaning command for the determined target cleaning region, identifying the cleaning command from the voice input based on a result of interpreting the voice input by using a natural language understanding model, generating a control command to control an operation of the robot cleaner from the identified cleaning command, and transmitting the control command to the robot cleaner.

An embodiment of the present disclosure provides a computer program product including a computer-readable storage medium having recorded thereon a program to be executed on a computer. In an embodiment of the present disclosure, the storage medium may include instructions to perform a method, performed by an electronic apparatus, of controlling a robot cleaner, the method including obtaining information about at least one of a position of a position tracking tag device, a position of at least one home appliance located around the robot cleaner, and a relative position between the robot cleaner and the electronic apparatus, by using a wireless communication network, determining a target cleaning region based on the obtained at least one of position information, and transmitting the determined information about a target cleaning region to the robot cleaner.

A program executed by the electronic apparatus 1000 described in the disclosure may be implemented by hardware components, software components, and/or a combination of hardware components and software components. A program may be performed by all systems capable of executing computer-readable instructions.

Software may include computer programs, codes, instructions, or any combination of one or more thereof, and may construct the processing unit for desired operations or may independently or collectively command the processing unit.

Software may be implemented by computer programs including instructions stored in a computer-readable storage medium. A computer-readable recording medium includes, for example, magnetic storage media (e.g., read-only memory (ROM), random-access memory (RAM), floppy disks, hard disks, and the like), optical media (e.g., CD-ROM, digital versatile disc (DVD)), and the like. A computer-readable recording medium may be distributed over network coupled computer systems so that it may be stored and executed in a distributed fashion. A medium may be readable by a computer, stored in a memory, and executable by a processor.

A computer-readable storage medium may be provide in the form of a non-transitory storage medium. Here, “non-transitory” merely means that the storage media do not contain signals and are tangible, but do not distinguish data being semi-permanently or temporarily stored in the storage media. In an example, a non-transitory storage medium may include a buffer in which data is temporarily stored.

Furthermore, the operation method of an electronic device according to the disclosed embodiments may be provided by being included in a computer program product. A computer program product as goods may be dealt between a seller and a buyer.

A computer program product may include a S/W program or a computer-readable storage medium where the S/W program is stored. For example, a computer program product may include a product in the form of a S/W program, for example, a downloadable application, that is electronically distributed through a manufacturer of a broadcast receiving device or an electronic market (e.g., Google PlayStore™ or AppStore™). For electronic distribution, at least part of a S/W program may be stored in a storage medium or temporarily generated. In this case, a storage medium may be a manufacturer's server, an electronic market's server, or a storage medium of a relay server that temporarily stores a SW program.

In a system including the electronic apparatus 1000, the server 3000 (see FIGS. 10 and 11), and other electronic apparatuses, a computer program product may include a storage medium of the server 3000 or a storage medium of an electronic apparatus. Alternatively, when there is a third device communicatively connected to the electronic apparatus 1000, the computer program product may include a storage medium of the third device. Alternatively, the computer program product may include a software program transmitted from the electronic apparatus 1000 to an electronic apparatus or the third device, or from the third device to the electronic apparatus.

In this case, one of the electronic apparatus 1000, the server 3000, and the third device may perform the method according to the disclosed embodiments by executing the computer program product. Alternatively, two or more of the electronic apparatus 1000, the server 3000, and the third device may perform the method according to the disclosed embodiments by executing the computer program product in a distributed fashion.

For example, as the electronic apparatus 1000 executes a computer program product stored in the memory 1500 (see FIG. 2), other electronic apparatus communicatively connected to the electronic apparatus 1000 may be controlled to perform the method according to the disclosed embodiments.

In another example, as a third device executes a computer program product, the electronic apparatus communicatively connected to the third device may be controlled to perform a method according to the disclosed embodiment.

When a third device executes a computer program product, the third device may download a computer program product from the electronic apparatus 1000, and execute the downloaded computer program product. Alternatively, a third device may execute a computer program product provided in a pre-loaded state to perform a method according to the disclosed embodiments.

While this disclosure has been particularly shown and described with reference to preferred embodiments thereof, it will be understood by those of ordinary skill in the art that various changes in form and details may be made therein without departing from the spirit and scope of the disclosure as defined by the appended claims. For example, an appropriate result may be achieved even when the described technologies are performed in a different order from the described method, and/or the constituent elements of the described computer system, module, or the like are coupled or combined in a different form from the described method, or replaced or substituted by other constituent elements or equivalents.

1. An electronic apparatus for controlling a robot cleaner, the electronic apparatus comprising:
a communication interface configured to perform data transceiving by using a wireless communication network;
a memory to store at least one instruction; and
at least one processor configured to execute the at least one instruction stored in the memory to:
obtain position information, by using the communication interface, based on at least one of a position tracking tag device, a position of at least one home appliance located around the robot cleaner, and a relative position between the robot cleaner and the electronic apparatus;
determine a target cleaning region based on the obtained position information; and
control the communication interface to transmit information about the determined target cleaning region to the robot cleaner.

2. The electronic apparatus of claim 1, wherein the at least one processor obtains the position information based on the position of the tracking tag device, and
the at least one processor is further configured to determine a region within a preset radius as the target cleaning region using the obtained position information based on the position of the position tracking tag device.

3. The electronic apparatus of claim 1, wherein the robot cleaner comprises a short-range wireless communication module that wirelessly performs data transceiving, and
the position information is obtained based on the position of the at least one home appliance that is obtained by the robot cleaner from the at least one home appliance by using the short-range wireless communication module.

4. The electronic apparatus of claim 3, further comprising a display,
wherein the at least one processor is further configured to:
receive device identification information of the at least one home appliance from the robot cleaner by using the communication interface, and identify a type of the at least one home appliance based on the received device identification information; and
control the display to display a user interface (UI) representing the type and the position of the at least one home appliance.

5. The electronic apparatus of claim 1, wherein the at least one processor is further configured to:
obtain information about air quality of an indoor space from the robot cleaner by using the communication interface; and
determine an area in which an air pollution degree exceeds a preset threshold value of the determined target cleaning region, as an intensive target cleaning region, based on the obtained information about the air quality.

6. The electronic apparatus of claim 1, further comprising:
a geomagnetic sensor to measure an azimuth of the electronic apparatus; and
a gyro sensor and an acceleration sensor to measure a rotation angle or an inclination angle of the electronic apparatus,
wherein the at least one processor is further configured to:
obtain information about a height and a direction of the electronic apparatus from the azimuth measured by using the geomagnetic sensor, and obtain information about the inclination angle of the electronic apparatus by using the gyro sensor and the acceleration sensor; and
obtain information about the relative position between the robot cleaner and the electronic apparatus by using the position information based on the position of the robot cleaner which is received by using an ultra wide band (UWB) and the information including at least one of the height, the direction, and the inclination angle of the electronic apparatus.

7. The electronic apparatus of claim 6, further comprising a camera to photograph a region to be cleaned by a user,
wherein the at least one processor is further configured to:
identify the region that is photographed by the camera based on a field of view (FOV) of the camera and the position information based on the relative position between the electronic apparatus and the robot cleaner; and
determine the identified region as the target cleaning region.

8. The electronic apparatus of claim 1, further comprising a microphone to receive a voice input including a cleaning command for the determined target cleaning region,
wherein the at least one processor is further configured to:
identify the cleaning command from the voice input based on a result of interpreting the voice input by using a natural language understanding model, and generate a control command to control an operation of the robot cleaner from the identified cleaning command; and
control the communication interface to transmit the control command to the robot cleaner.

9. A method, performed by an electronic apparatus, of controlling a robot cleaner, the method comprising:
obtaining position information, by using a wireless communication network, based on at least one of a position tracking tag device, a position of at least one home appliance located around the robot cleaner, and a relative position between the robot cleaner and the electronic apparatus;
determining a target cleaning region based on the obtained position information; and
transmitting information about the determined target cleaning region to the robot cleaner.

10. The method of claim 9, wherein the determining of the target cleaning region comprises determining a region within a preset radius as the target cleaning region using the obtained position information based on the position tracking tag device.

11. The method of claim 9, wherein the robot cleaner comprises a short-range wireless communication module that wirelessly performs data transceiving, and the position information is obtained based on the position of the at least one home appliance that is obtained by the robot cleaner from the at least one home appliance by using the short-range wireless communication module.

12. The method of claim 11, further comprising:
receiving device identification information of the at least one home appliance from the robot cleaner;
identifying a type of the at least one home appliance based on the received device identification information; and
displaying a user interface UI representing the type and the position of the at least one home appliance.

13. The method of claim 9, wherein the determining of the target cleaning region comprises:
photographing a region to be cleaned by a user by using a camera;
identifying a region photographed by the camera based on a field of view (FOV) of the camera and the position information based on the relative position between the electronic apparatus and the robot cleaner; and
determining the identified region as the target cleaning region.

14. The method of claim 9, further comprising:
receiving a voice input including a cleaning command for the determined target cleaning region;
identifying the cleaning command from the voice input based on a result of interpreting the voice input by using a natural language understanding model;
generating a control command to control an operation of the robot cleaner from the identified cleaning command; and
transmitting the control command to the robot cleaner.

15. A computer program product comprising a non-transitory computer-readable storage medium having recorded thereon instructions to perform a method, performed by an electronic apparatus, of controlling a robot cleaner, the method comprising:
obtaining position information, by using a wireless communication network, based on at least one of a position tracking tag device, a position of at least one home appliance located around the robot cleaner, and a relative position between the robot cleaner and the electronic apparatus;
determining a target cleaning region based on the obtained position information; and
transmitting information about the determined target cleaning region to the robot cleaner.
